(19) United States
(12) Patent Application Publication
(10) Pub. No.: US 2024/0290997 A1
(43) Pub. Date: Aug. 29, 2024

(54) SYSTEMS AND METHODS FOR REDUCING COSTS AND PARASITIC LOADS WHEN USING AN EJECTOR WITH A FUEL CELL

(71) Applicants: CUMMINS INC., Columbus, IN (US); HYDROGENICS CORPORATION, Mississauga (CA)

(72) Inventors: Richard J. ANCIMER, Toronto, ON (CA); Eero Andresson Aherma TEENE, Hamilton, ON (CA); Paolo FORTE, Maple, ON (CA)

(21) Appl. No.: 18/572,393

(22) PCT Filed: Jun. 20, 2022
(86) PCT No.: PCT/US2022/034150

§ 371 Date: Dec. 20, 2023

Related U.S. Application Data
(60) Provisional application No. 63/215,075, filed on Jun. 25, 2021.

(51) Int. Cl. H01M 8/04007; H01M 8/04089; H01M 8/04701; H01M 8/04746

(52) U.S. Cl. CPC H01M 8/04067; H01M 8/04097; H01M 8/04708; H01M 8/04753

(57) ABSTRACT

The present disclosure generally relates to systems and methods for optimizing the use of a venturi or an ejector and reducing costs and parasitic loads associated with using the venturi or an ejector with a recirculation pump or blower in a fuel cell, fuel cell stack, and/or fuel cell system.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/215,075 filed on Jun. 25, 2021, the entire disclosure of which is hereby expressly incorporated herein by reference.

### TECHNICAL FIELD

The present disclosure relates to systems and methods for optimizing the use of a venturi or an ejector and to systems and methods for reducing costs and parasitic loads associated with using the venturi or an ejector with a recirculation pump or blower in a fuel cell, fuel cell stack, and/or fuel cell system.

### BACKGROUND

Vehicles and/or powertrains use fuel cells, fuel cell stacks, and/or fuel cell systems for their power needs. A minimum excess fuel target for a fuel cell system may be specified as a minimum level of an excess fuel target required by the fuel cell or fuel cell stack based on the operating conditions of the fuel cell, stack or system. A fuel cell or fuel cell stack may have an excess fuel level higher than the minimum excess fuel target, but achieving that higher level may result in a high parasitic load on the fuel cell or fuel cell stack. For example, the excess fuel level higher than the minimum excess fuel target may be achieved by maintaining high fuel flow rates at the anode, which may lead to a pressure loss in the fuel cell, stack, or system.

A blower and/or a pump (e.g., a recirculation pump) may function at a capacity proportional to the pressure loss in the fuel cell or fuel cell stack. The blower and/or the pump may also function at a capacity proportional to a volumetric flow rate through the blower and/or the pump. A blower and/or a pump may use additional power to compensate for the pressure loss. However, use of additional power by the blower and/or the pump may result in a high parasitic load on the fuel cell, fuel cell stack and/or fuel cell system. The present disclosure relates to systems and methods for optimizing use of a venturi or an ejector to overcome the high costs and parasitic loads associated with using a recirculation pump or blower in a fuel cell system comprising a fuel cell and/or a fuel cell stack.

### SUMMARY

Embodiments of the present invention are included to meet these and other needs. In one aspect of the present disclosure, described herein is a fuel cell, fuel cell stack, and/or fuel cell system. The fuel cell system has an ejector. The ejector has a first fuel entering a first inlet at a first pressure (P_{O}) and a second fuel entering a second inlet at a second pressure (P_{S}). The first fuel and the second fuel exit an ejector exit at an ejector exit pressure. The ejector is sized to fully deliver the second fuel for a required entrainment ratio (ER) at a critical current density. The fuel cell system is required to operate at an operating current density and at an operating pressure within an operating pressure range. The operating pressure is at or above the critical current density and the ejector has an effective efficiency (η).

In some embodiments, the operating pressure may range from a low pressure to a high pressure. In some embodiments, the operating pressure of the fuel cell system at the operating current density may be set to be below the ejector exit pressure (P_{C}) that satisfies the relationship (P_{C}/P_{O})^{κ}<P_{S}/P_{C}. In some embodiments, κ=(R__{A}/R__{B}) (η/ER), R_{A} may be the gas constant of the first fuel and R_{B} may be the gas constant of the second fuel.

In some embodiments, the fuel cell system may include an anode gas recirculation loop and the ejector size may depend on a pressure loss (ΔP_{LIFT}) through the anode gas recirculation loop. In some embodiments, the pressure loss (ΔP_{LIFT}) may vary with operating conditions including operating current density and operating pressure. In some embodiments, (P_{C}/P_{O})^{K}<1−ΔP_{LIFT}/P_{C}. In some embodiments, κ=(R__{A}/R__{B}) (η/ER), R_{A} may be the gas constant of the first fuel and R_{B} may be the gas constant of the second fuel.

In some embodiments, the ejector may be sized to fully deliver the second fuel for the required entrainment ratio (ER) at the critical current density without assistance of a blower.

In some embodiments, the first pressure (P_{O}) may depend on a temperature of the first fuel at the first inlet.

In some embodiments, the ejector may be sized to meet the target entrainment ratio at or above a current density threshold. In some embodiments, the target entrainment ratio may be based on a minimum excess fuel ratio or a minimum anode gas inlet humidity.

In some embodiments, the fuel cell system may further include a blower upstream or downstream the ejector.

In some embodiments, the effective efficiency (η) may vary with operating conditions of the ejector.

In a second aspect of the present disclosure, a method of operating a fuel cell system includes the steps of flowing a first fuel at a first pressure (P_{O}) through a first inlet in an ejector, flowing a second fuel at a second pressure (P_{S}) through a second inlet in the ejector, exiting a mixture of the first fuel and second fuel at an ejector exit with an ejector exit pressure (P_{C}), sizing the ejector to fully deliver the second fuel at a critical current density, and operating the fuel cell system at an operating current density and with an operating pressure. The operating pressure is at or above the critical current density and the ejector as an effective efficiency (η).

In some embodiments, the operating pressure may range from a low pressure to a high pressure. In some embodiments, the operating pressure of the fuel cell system at the operating current density may be set to be below the ejector exit pressure (P_{C}) that satisfies the relationship (P_{C}/P_{O})^{κ}<P_{S}/P_{C}. In some embodiments, κ=(R__{A}/R__{B}) (η/ER), R_{A} may be the gas constant of the first fuel and R_{B} may be the gas constant of the second fuel.

In some embodiments, the fuel cell system may include an anode gas recirculation loop and the ejector size may depend on a pressure loss (ΔP_{LIFT}) through the anode gas recirculation loop. In some embodiments, the pressure loss (ΔP_{LIFT}) may vary with operating conditions including operating current density and operating pressure. In some embodiments, (P_{C}/P_{O})^{K}<1−ΔP_{LIFT}/P_{C}. In some embodiments, κ=(R__{A}/R__{B}) (η/ER), R_{A} may be the gas constant of the first fuel and R_{B} may be the gas constant of the second fuel.

In some embodiments, the ejector may be sized to fully deliver the second fuel for the required entrainment ratio (ER) at the critical current density without the assistance of a blower.

In some embodiments, the ejector may be sized to meet a target entrainment ratio (ER). In some embodiments, the target entrainment ratio may depend on a minimum excess fuel ratio or a minimum anode gas inlet humidity.

In some embodiments, the method may include preconditioning the first fuel before entering the first inlet. In some embodiments, the preconditioning may include heating or cooling the first fuel up to a sizing temperature. In some embodiments, the sizing temperature may depend on operating conditions of the fuel cell system.

In some embodiments, the method may include operating a blower upstream or downstream the ejector.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 A is an illustration of a fuel cell system including one or more fuel cell stacks connected to a balance of plant.

FIG. 1B is an illustration showing a fuel cell module and fuel cell system comprising a fuel cell or a fuel cell stack.

FIG. 1C is an illustration of components of a fuel cell in the fuel cell stack.

FIG. 2 is a graph showing the operating curves of a system comprising a fuel cell or fuel cell stack.

FIG. 3 is a schematic showing a mechanical regulator used along with a venturi or an ejector in a fuel cell system.

FIG. 4 is a schematic showing a proportional control valve used along with a venturi or an ejector in a fuel cell system.

FIG. 5A is a graph showing operating curves of as system comprising a venturi or an ejector under choked conditions.

FIG. 5B is a graph showing the operating curves of as system comprising a venturi or an ejector under choked and unchoked conditions.

FIG. 6 is a schematic showing a blower downstream of a venturi or an ejector in a fuel cell system.

### DETAILED DESCRIPTION

The present disclosure relates to systems and methods for optimizing the use of a venturi and/or an ejector with a fuel cell or fuel stack in a fuel cell system or fuel cell stack system. The present disclosure also relates systems and methods for overcoming high costs and parasitic loads associated with a recirculation pump or a blower in the fuel cell or fuel cell stack. More specifically, this disclosure relates to systems and methods for optimizing and/or balancing the fuel supply limits and ranges with the operating requirements of the fuel cell or fuel cell system, improving the venturi or ejector performance by introducing primary fuel temperature conditioning across all operating modes of the fuel cell or fuel cell stack, and optimizing the positioning of the recirculation pump or blower in relation to the venturi or ejector.

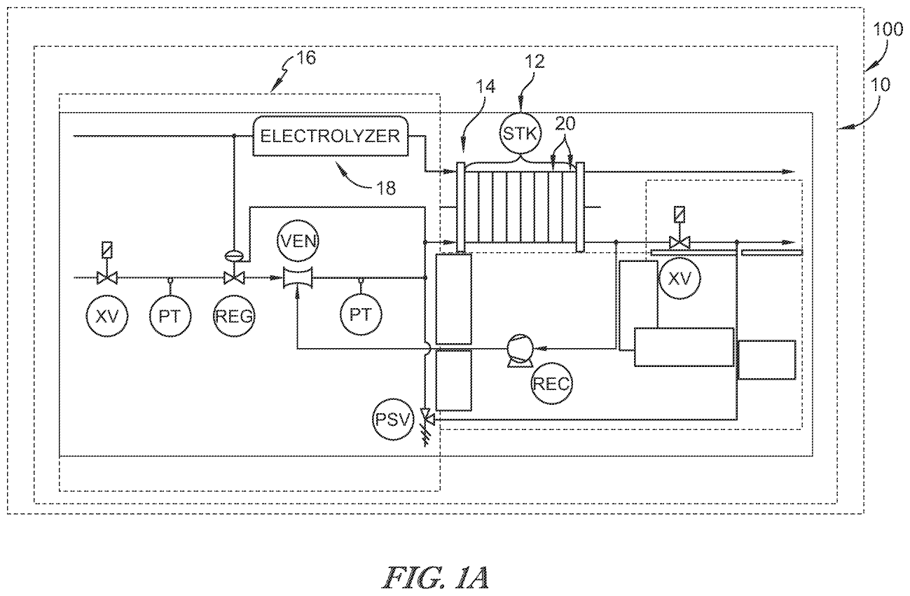

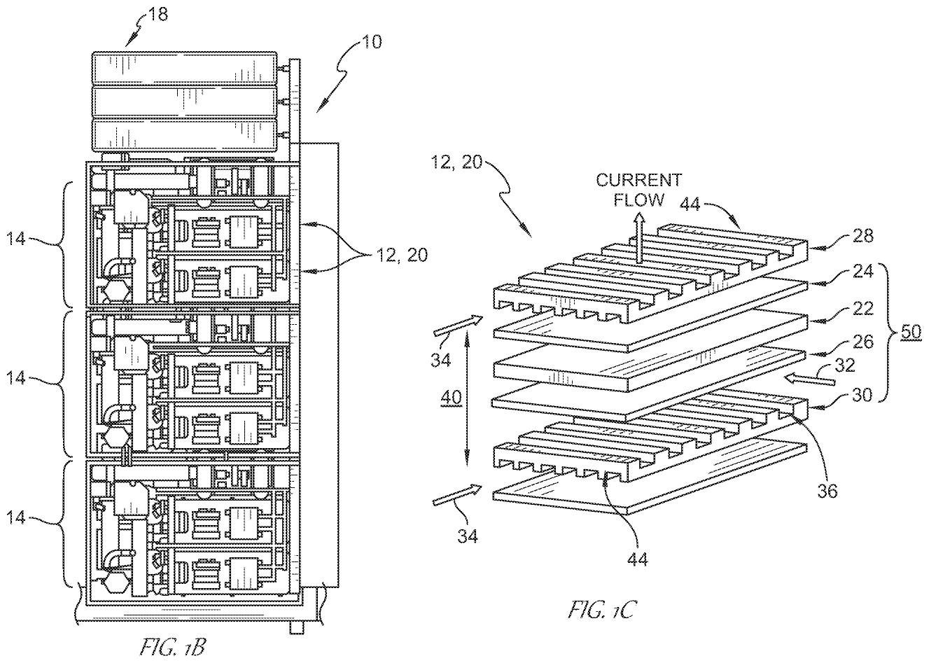

As shown in FIG. 1A, fuel cell systems 10 often include one or more fuel cell stacks 12 or fuel cell modules 14 connected to a balance of plant (BOP) 16, including various components, to create, generate, and/or distribute electrical power for meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 connected together in series and/or in parallel. The fuel cell system 10 may include one or more fuel cell modules 14 as shown in FIGS. 1A and 1B. Each fuel cell module 14 may include a plurality of fuel cell stacks 12 and/or a plurality of fuel cells 20.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26. The above mentioned components, 22, 24, 26, 30 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plate (BPP) 28, 30 can uniformly distribute reactants 32, 34 to an active area 40 of each fuel cell 20 through oxidant flow fields 42 and/or fuel flow fields 44. The active area 40, where the electrochemical reactions occur to generate electrical power produced by the fuel cell 20, is centered within the gas diffusion layer (GDL) 24, 26 and the bipolar plate (BPP) 28, 30 at the membrane electrode assembly (MEA) 22. The bipolar plate (BPP) 28, 30 are compressed together to isolate and/or seal one or more reactants 32 within their respective pathways, channels, and/or flow fields 42, 44 to maintain electrical conductivity, which is required for robust during fuel cell 20 operation.

The fuel cell system 10 described herein, may be used in stationary and/or immovable power system, such as industrial applications and power generation plants. The fuel cell system 10 may also be implemented in conjunction with electrolyzers 18 and/or other electrolysis system 18. In one embodiment, the fuel cell system 10 is connected and/or attached in series or parallel to an electrolysis system 18, such as one or more electrolyzers 18 in the BOP 16. In another embodiment, the fuel cell system 10 is not connected and/or attached in series or parallel to an electrolysis system 18, such as one or more electrolyzers 18 in the BOP 16.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy duty vehicle.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

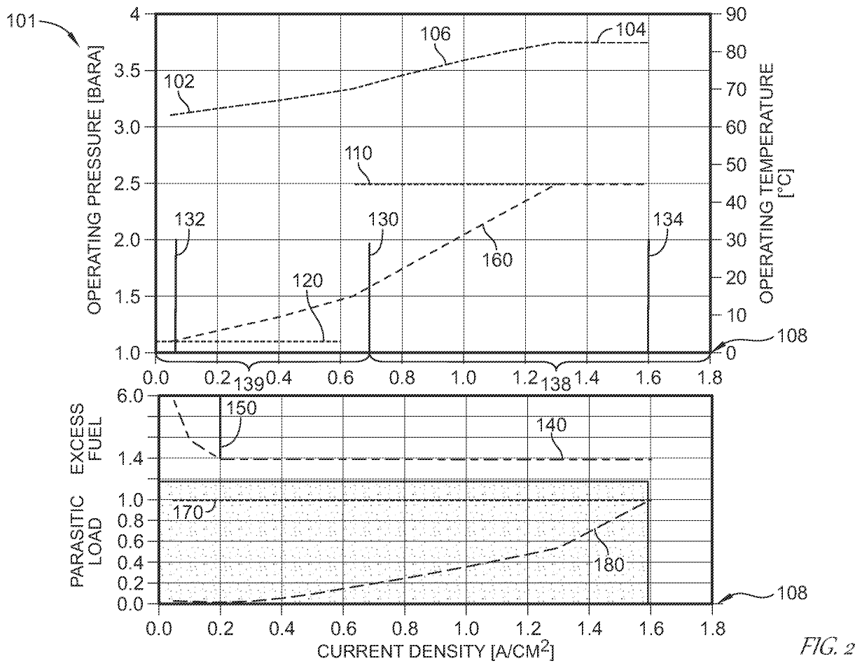

One embodiment of the operating characteristics of a fuel cell system 10 comprising a fuel cell 20 or fuel cell stack 12 is illustrated in graph 101 in FIG. 2. Operating pressures and the associated operating temperatures are shown as a function of current density 108. The fuel cell 20 or fuel cell stack 12 may be required to operate within a pressure range known as anode inlet manifold pressure (P_{AIM}) measured at the anode inlet manifold 213.

A highest anode inlet manifold pressure (P_{AIM_HI}) of a fuel cell 20 or fuel cell stack 12 is denoted by 110. A lowest anode inlet manifold pressure (P_{AIM_HI}) of a fuel cell 20 or fuel cell stack 12 is denoted by 120. The range 160 between the highest anode inlet manifold pressure (P_{AIM_HI}) 110 and the lowest anode inlet manifold pressure (P_{AIM_LO}) 120 indicates a target anode inlet manifold pressure range or operating pressure. A target temperature of the fuel cell system 10 may range from a low fuel supply operating temperature (T_{CV_LO}) 102 to a high fuel supply operating temperature (T_{CV_HI}) 104.

It is critical to operate the fuel cell 20 or fuel cell stack 12 at a pressure that ranges from about or approximately the highest anode inlet manifold pressure (P_{AIM_HI}) 110 to about or approximately the lowest anode inlet manifold pressure (P_{AIM_LO}) 120 when the fuel cell 20 or fuel cell stack 12 is operating above a critical current density (i__{LO_CR}) 130. In some embodiments, the critical current density (i__{LO_CR}) 130 may be at about 0.7 A/cm². In other embodiments, the critical current density (i__{LO_CR}) 130 may be at about 0.6 A/cm². In some further embodiments, the critical current density (i__{LO_CR}) 130 may be higher or lower than 0.7 A/cm², such as ranging from about 0.5 A/cm² to about 0.9 A/cm², including every current density 108 or range of current density 108 comprised therein.

The fuel cell 20 or fuel cell stack 12 may operate at a high current density 138, which may be higher than the critical current density (i__{LO_CR}) 130. The high current density 138 may range from about 1.3 A/cm² to about 2.0 A/cm², or about 1.3 A/cm² to about 1.6 A/cm², or about 1.0 A/cm² to about 1.6 A/cm², including every current density 108 or range of current density 108 comprised therein.

In some embodiments, operating the fuel cell 20 or fuel cell stack 12 at such high current density 138 (e.g., at about 1.6 A/cm²) will result in operating the fuel cell 20 or fuel cell stack 12 at pressures and temperatures different from optimal target operating pressures and operating temperatures. Operating the fuel cell 20 or fuel cell stack 12 at pressures and temperatures different from the optimal target operating pressures and operating temperatures may lower the efficiency of the fuel cell 20 or fuel cell stack 12. Such operation may also result in damage to the fuel cell 20 or fuel cell stack 12 because of MEA 22 degradation (e.g., due to starvation, flooding and/or relative humidity effects). In some embodiments, there may be more flexibility in the fuel cell 20 or fuel cell stack 12 operating pressure and operating temperature when the fuel cell 20 or fuel cell stack 12 is operating below the critical current density (i__{LO_CR}) 130. The present operating system comprising the fuel cell or fuel cell stack can operate at a minimum current density (i_{MIN}) 132 and/or a maximum current density (I_{MAX}) 134.

In one embodiment, the fuel cell system 10 comprising the fuel cell 20 or fuel cell stack 12 may operate in a functional range that may be different than that indicated by the curve 160 in FIG. 2. The fuel cell system 10 may operate at higher pressures (e.g., the highest anode inlet manifold pressure (P_{AIM_HI}) 110) or at a current density 108 as low as the critical current density (i__{LO_CR}) 130. For example, the fuel cell system 10 may extend steady state operation at about 2.5 bara down to about the critical current density (i__{LO_CR}) 130. Pressure measurements in bara refer to the absolute pressure in bar.

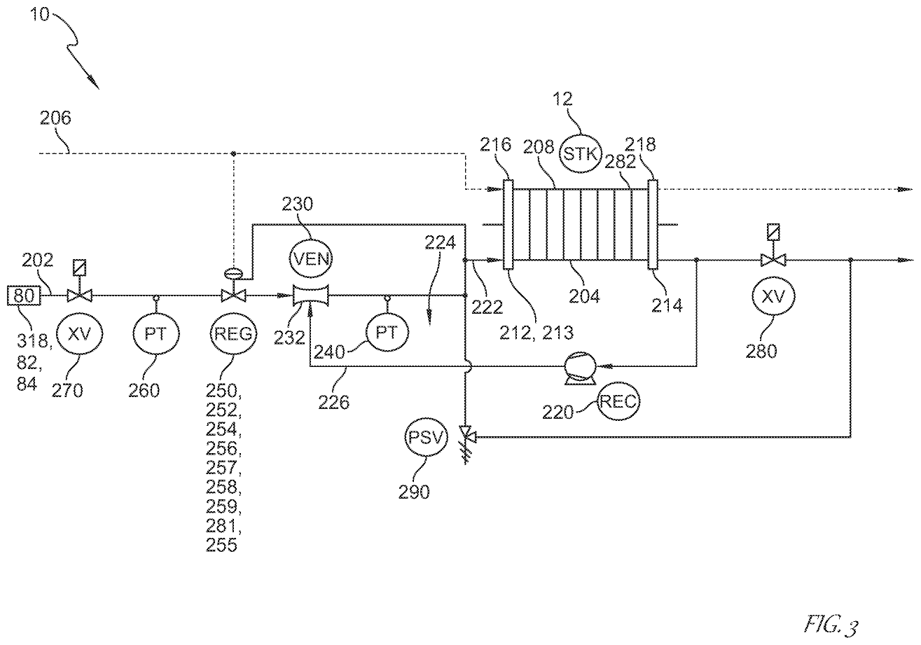

FIG. 3 illustrates one embodiment of a fuel cell system 10 comprising a fuel cell stack 12, a mechanical regulator 250, a recirculation pump or blower 220 in series or in parallel to the fuel cell stack 12, an exhaust valve 280, a shut off valve 270, a pressure transfer valve 290, one or more pressure transducers 240/260, and a venturi or an ejector 230. In some embodiments, the fuel cell system 10 may comprise one or more fuel cell stacks 12 and/or one or more fuel cells 20. In other embodiments, there may also be one or multiple valves, sensors, compressors, regulators, blowers, injectors, ejectors, and/or other devices in series or in parallel with the fuel cell stack 12.

In one embodiment of the fuel cell system 10, an anode inlet stream 222, flows through an anode 204 end of the fuel cell stack 12. Typically, the anode inlet stream 222 may be a mixture of fresh fuel (e.g., H₂) and anode exhaust (e.g., H₂ fuel and/or water). Conversely, oxidant 206 (e.g., air, oxygen, or humidified air) may flow through the cathode 208 end of the fuel cell stack 12.

Excess fuel may be provided at the anode inlet 212 to avoid fuel starvation towards the anode outlet 214. Water content of the anode inlet stream 222 or the relative humidity of the anode inlet stream 222 may impact the performance and health of the fuel cell stack 12. For example, low inlet humidity may lead to a drier membrane electrode assembly (MEA) 22, resulting in reduced performance.

Low inlet humidity may also induce stresses that can lead to permanent damage to the membrane electrode assembly (MEA) 22. High humidity levels may lead to flooding within the fuel cell 20 or fuel cell stack 12, which can induce local starvation and/or other effects that may reduce fuel cell performance and/or damage the membrane electrode assembly (MEA) 22. In some embodiments, there may be an optimal inlet relative humidity range in which fuel cell performance is improved and membrane electrode assembly (MEA) 22 degradation rate is minimized. For example, the fuel cell 20 or fuel cell stack 12 may achieve optimal performance when the relative humidity level of the anode inlet stream 222 is in the range of about 30% to about 35%, including any percentage or range comprised therein.

The source of the excess fuel and water content in a fuel cell 20 may be from a secondary or recirculated flow 226. Composition of the secondary flow 226 in the fuel cell system 10 is dependent on its composition of anode outlet stream 225. In some embodiments, the anode outlet stream 225 may be saturated with water at a given anode gas outlet temperature and pressure. Thus, the variation in the composition of the secondary flow 226 may be taken into account when determining a required secondary flow 226 to meet the excess fuel or relative humidity targets of the anode inlet stream 222.

The required flow rate of the secondary flow 226 can be determined by either the need for excess fuel, or by the need for increased water content, whichever calls for a higher flow of the secondary flow 226. The required flow of the secondary flow 226 can be expressed as the target entrainment ratio (ER). The entrainment ratio (ER) is defined as the ratio of mass flow rate of the low pressure stream (e.g., the secondary mass flow rate) to the mass flow rate of the high pressure stream (e.g., the primary mass flow rate). Alternatively, a target effective excess fuel ratio or a minimum required fuel ratio may account for either the need for excess fuel, or for the increased water content of the anode inlet stream 222.

Excess fuel ratio (λ) or the anode stoichiometry ratio is defined as the ratio of anode inlet fuel flow rate to the fuel consumed in the fuel cell 20 or fuel cell stack 12. Excess fuel ratio (λ) may be used to represent the required composition of the secondary flow 226 to meet the required anode inlet stream 222 characteristics. The required anode inlet stream 222 characteristics may be the more stringent of excess fuel ratio or relative humidity requirements of the fuel cell system 10.

Excess fuel ratio (λ) or the anode stoichiometry ratio is defined as the ratio of anode inlet stream 222 flow rate to the fuel consumed in the fuel cell 20 or fuel cell stack 12. Minimum required excess fuel ratio (λ) 140 as a function of current density 108 is shown in FIG. 2. In some embodiments, the fuel cell system 10 requires a fuel amount at or above the minimum required excess fuel ratio (λ) 140.

In other embodiments, the fuel cell system 10 may require a target water or humidity level, which may affect the excess fuel ratio (λ) 140. The excess fuel ratio (λ) 140 may be flat across the fuel cell system 10 operating range except at low current densities 108, such as at a current density 108 at or below an excess fuel ratio current density threshold (i__{λ_THV}) 150. Alternatively, or additionally, the excess fuel ratio (λ) 140 may change with a change in current density 108.

In some embodiments, the excess fuel ratio (λ) 140 above the excess fuel ratio current density threshold (i__{λ_THV}) 150 may be in the range from about 1.3 to about 1.9, including any ratio comprised therein. In one preferable embodiment, the excess fuel ratio (λ) 140 above the excess fuel ratio current density threshold (i__{λ_THV}) 150 may be in the range of about 1.4 to about 1.6, including any ratio or range of ratio comprised therein.

In some embodiments, the excess fuel ratio current density threshold (i__{λ_THV}) 150 of the fuel cell system 10 may be at or about 0.2 A/cm². In other embodiments, the excess fuel ratio current density threshold (i__{λ_THV}) 150 may be at a different current density 108. For example, the excess fuel ratio current density threshold (i__{λ_THV}) 150 may be at a current density 108 in the range of about 0.05 A/cm² to about 0.4 A/cm², including any current density 108 or range of current density 108 comprised therein. In one preferable embodiment, the excess fuel ratio current density threshold (i__{λ_THV}) 150 may be about 0.1 A/cm² or about 0.2 A/cm². The excess fuel ratio current density threshold (i__{λ_THV}) 150 may depend on the operating conditions of the fuel cell 20 or fuel cell stack 12.

In one embodiment, if the fuel cell 20 or fuel cell stack 12 is operating below the excess fuel ratio current density threshold (i__{λ_THV}) 150, a minimum volumetric flow rate may be maintained through the anode 204 to flush out any liquid water that might form in the fuel cell 20 or fuel cell stack 12. At low flow rates (e.g., below about 0.2 A/cm² or below about 0.1 A/cm²), there may be flooding in the fuel cell 20 or fuel cell stack 12. If the minimum volumetric flow rate is below the excess fuel ratio current density threshold (i__{λ_THV}) 150, the rate of fuel cell 20 or fuel cell stack 12 degradation may increase.

A venturi or an ejector 230 may be used in the fuel cell system 10. The venturi or ejector 230 may be sized, such that the fuel cell system 10 may not require the assistance of a recirculation pump 220, such as a blower, at certain current densities 108. Absence of usage of the recirculation pump or blower 220 may result in a decrease in parasitic load, as shown by the curves 170 and 180 of FIG. 2.

The curve 170 shows a fraction of flow that is delivered by the recirculation pump or blower 220 in the absence of a venturi or ejector 230. The curve 180 shows the corresponding parasitic load. The parasitic load may increase with an increase in current density, as shown by the curve 180. This is because the recirculation pump or blower 220 may function at a capacity proportional to pressure loss in the fuel cell 20 or fuel cell stack 12 and/or proportional to the required flow rate of the secondary flow 226 in the fuel cell 20 or fuel cell stack 12.

The fuel cell 20 or fuel cell stack 12 may be initially operating at high current density 138 and/or at high operating temperatures and pressures, such that the fuel cell load under this initial operating condition is high. The fuel cell load is defined as: Load=stack power=current×fuel cell or fuel cell stack voltage=current density×fuel cell area×fuel cell or fuel cell stack voltage.

The fuel cell 20 or fuel cell stack 12 may be in a load shedding state when the load demand for power is rapidly reduced or shed requiring the fuel cell 20 or fuel cell stack 12 to reduce the current delivered.

During transient operations in the fuel cell 20 or fuel cell stack 12, the operating pressure in the fuel cell 20 or fuel cell stack 12 may change based on the changes in the fuel cell 20 or fuel cell stack 12 operating temperature. For example, during load shedding, the fuel cell system 10 may have an operating pressure that corresponds to a transient operating pressure (P__{AIM_TRS}) that may be greater than its steady state operating pressure (P__{AiM_SS}). In some embodiments, the transient operating pressure (P__{AIM_TRS}) may equal the highest anode inlet manifold pressure (P_{AIM_HI}) 110 even at low current densities 108. During load acceptance, the rate of increase in current density 108 is limited, and the steady state operating pressure (P__{AIM_SS}) may equal the anode inlet manifold pressure (P_{A1M}).

In one embodiment, the operating pressure of the fuel cell 20 or fuel cell stack 12 may optimize the balance between enabling efficient fuel cell 20 or fuel cell stack 12 operation and the parasitic load required to operate at the chosen operating pressure (e.g., the parasitic load of an air compressor, a blower, and/or a pump). In some embodiments, the operating temperature, operating pressure, and/or excess air ratio 140 may maintain a target relative humidity (RH) for the fuel cell 20 or fuel cell stack 12 operation. The operating temperature, operating pressure, and/or excess air ratio 140 may be determined by targeting a specific value for the relative humidity (RH) at the cathode 208.

The excess air ratio is defined similarly to excess fuel ratio 140, but refers to the cathode 208 side flow (i.e., excess O₂ in the air). The combination of excess air ratio, pressure and temperature are used together to control humidity on the cathode 208 side, which in turn impacts water content on the anode 204 (H₂) side. In one embodiment, temperature, pressure, and excess air ratio that vary with current density may be used to control humidity on the cathode 208 side. In some embodiments, excess air ratio may be about 2.0. In other embodiments, excess air ratio may be in the range of about 1.7 to about 2.1, including any ratio or range of ratio comprised therein. In some other embodiments, excess air ratio may be in the range of about 1.8 to about 1.9, including any ratio or range of ratio comprised therein, under pressurized operation. Excess air ratio may increase to below an air threshold current to keep volumetric flow rate high enough to prevent flooding in the fuel cell 20 or fuel cell stack 12 on the cathode 208 side.

The target relative humidity (RH) may be maintained by using a humidification device in combination with the operating pressure and operating temperature. For example, a humidification device may be used on the cathode 208 side of the fuel cell 20 or fuel cell stack 12. If the target relative humidity (RH) and the target operating pressure of the fuel cell 20 or fuel cell stack 12 are specified, the target temperature for the fuel cell 20 or fuel cell stack 12 operation may be determined.

The mechanical regulator 250 is a control valve 254 that may be used to control the flow of fresh fuel 202 also referred to as primary flow, primary mass flow, primary fuel, or motive flow to the anode 204. Pressure differential between the gas streams (e.g. anode inlet stream 222 and air 206) at the anode 204 and the cathode 208 may provide an input signal 256 to a controller 252 in the mechanical regulator 250.

The controller 252 of the mechanical regulator 250 may determine the flow of the anode inlet stream 222 through an anode inlet 212 at the anode 204. The control valve 254 may be a proportional control valve, or an injector. In other embodiments, the control valve 256 may comprise an inner valve 258, coil 255, or solenoid 257 that controls the opening or closing of the control valve 254. The input signal 256 from the anode 204 and/or cathode 208 of the fuel cell 20 or fuel cell stack 12 may be a physical signal 256 or a virtual (e.g., an electronic) signal 256. The signal may be any type of communicative or computer signal 256 known in the art.

Flow rate of the primary flow 202, or a primary flow rate, may be controlled to match the fuel consumption in the fuel cell stack 12 based on the operating pressure (e.g., anode pressure). In some embodiments, the pressure in the anode 204 may stabilize when fuel consumption matches the fresh fuel feed at the anode 204 assuming that all other parameters are equal. Since the functioning of the mechanical regulator 250 is based on the pressure differential between the anode 204 and cathode 208, a target pressure differential needs to be maintained when using the mechanical regulator 250. In some embodiments, pressure at the cathode 208 is controlled and/or maintained at a target level via cathode side controls 282.

A mechanically regulated approach, such as by employing actuators 282, may use pressure signals 281 from a cathode/air inlet 216 to control mass flow and maintain an appropriate pressure on the cathode 208 side of the fuel cell stack 12. In some embodiments, pressure signals 218 from cathode 208 side are inputs to the mechanical regulator 250. In some embodiments, the anode 204 side mass flow and anode 204 side pressure may be controlled by using the pressure signals 281 from cathode 208 side and measuring one or more anode 204 side conditions.

The pressure signals 281 from cathode 208 side may change the position of an inner valve 258 in the mechanical regulator 250 to control mass flow through the mechanical regulator 250 and maintain the target pressure differential between the anode 204 and the cathode 208. The input signal 256 that acts on the mechanical regulator 250 is effectively a pressure differential that acts on a diaphragm 257 or other parts of the mechanical regulator 250. No other direct measurement of the pressure differential may be undertaken. A single point pressure at the anode 204 may be calculated to be the cathode 208 side pressure plus the pressure differential between the gas streams (e.g., 222) at the anode 204 and the gas streams (e.g., 206) at the cathode 208.

The venturi or ejector 230 may draw the secondary flow 226, also referred to as secondary mass flow, entrainment flow, or recirculation flow, using a flow pressure across an anode gas recirculation (AGR) loop 224. In some embodiments, the anode gas recirculation loop 224 may include the venturi or ejector 230, the fuel cell stack 12, and a secondary inlet 232, such as one comprised in a suction chamber 234 in the venturi or ejector 230, and/or other piping, valves, channels, manifolds associated with the venturi or ejector 230 and/or fuel cell stack 12. The recirculation pump or blower 220 may increase or decrease the differential pressure across the AGR loop 224.

The fuel cell system 10 may require a target water or humidity level, which may drive the flow of saturated secondary flow 226. The saturated secondary flow 226 may then drive the primary flow 202, such that the target excess fuel ratio (λ) 140 may be dependant on the target water or humidity level.

In one embodiment, the recirculation pump or blower 220 may be used to achieve the excess fuel ratio. The recirculation pump or blower 220 may operate across the entire operating range (current density) of the fuel cell stack 12. The parasitic load of the recirculation pump or blower 220 may be substantial. In one embodiment, a large recirculation pump or blower 220 may be required to provide the power to achieve the target excess fuel ratio (λ) 140. In some embodiments the use of the recirculation pump or blower 220 may be inefficient and expensive. The operating characteristics of a recirculation pump or blower 220 may be distinct from the operating conditions of the venturi or ejector 230.

The pressure lift capability of the recirculation pump or blower 220 (ΔP__{BLWR}) is a function of the flow through the recirculation pump or blower 220 (Q), the blower speed (N), and the density of the flow composition (ρ). The pressure lift of the recirculation pump or blower 220 (ΔP__{BLWR}) may be limited by power draw limits and/or speed limit of the fuel cell system 10. When the recirculation pump or blower 220 is not spinning or is operating under other fuel cell system 10 stall conditions, the recirculation pump or blower 220 may act as a restriction in the AGR loop 224.

ΔP__{BLWR}=f(Q,N,ρ) (1)

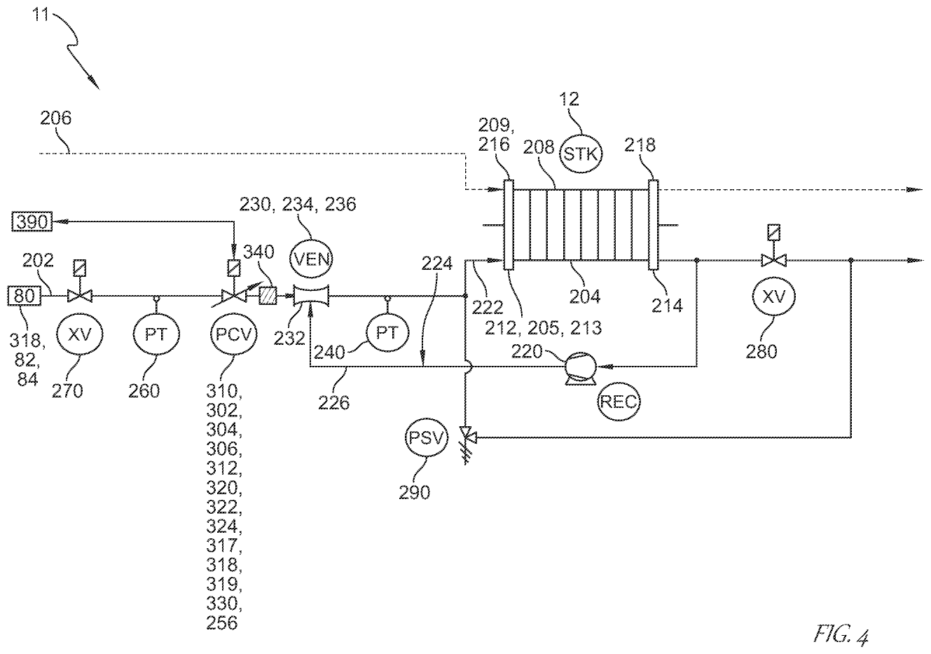

As illustrated in the operating fuel cell system 11 shown in FIG. 4, a proportional control valve 310 may be used instead of a mechanical regulator 250. A proportional control valve 310 is electronically controlled and may provide more flexibility in controlling single point pressure at the anode 204 than the mechanical regulator 250. The proportional control valve 310 may be used to control the primary flow in the fuel cell system 11. In other embodiments, an injector (not shown) may be used instead of a proportional control valve 310.

The proportional control valve 310 may beneficially allow for active management of the differential pressure, may avoid droop issues, and/or provide flexibility in operating the fuel cell stack 12 under different operating conditions. Illustrative operating conditions may include, but are not limited to operating current density, operating pressure, operating temperature, operating relative humidity, fuel supply pressure, fuel supply temperature, required secondary flow, entrainment ratio, parasitic load limitations, power needs, pressure loses in the AGR loop 224, venturi or ejector 230 performance and/or efficiency, recirculation pump or blower 220 performance and/or efficiency, fuel density, purge flow, and choked or unchoked (e.g., not choked) flow conditions.

The turn down ratio of the fuel cell system 10/11 is defined as the ratio of the maximum capacity of the venturi or ejector 230 to the minimum capacity of the venturi or ejector 230. The venturi or ejector 230 may draw the recirculation flow 226 using a primary flow exergy. The turn down ratio characterizes the range over which the venturi or ejector 230 can deliver the required excess fuel ratio (λ) 140 to the fuel cell stack 12. The fuel cell system 10/11 may be designed to maximize the venturi or ejector 230 turn down ratio. Consequently, maximizing the turn down ratio of the venturi or ejector 230 also works to minimize the size and parasitic load associated with the recirculation pump or blower 220. In some embodiments, the venturi or ejector 230 may be required to operate and/or perform robustly to deliver the required primary flow 202 at the required excess fuel ratio (λ) 140.

In one embodiment, a fuel supply system 80 may supply fuel at a fuel supply pressure (P_{CV}) and a fuel supply temperature (T_{CV}). The primary flow 202 may pass through the control valve 256 and enter the venturi or ejector 230 through a primary nozzle 236 at a primary nozzle inlet pressure (P_{O}) and a primary inlet temperature (T_{O}). The secondary flow 226 may enter the venturi or ejector 230 through a secondary inlet 232 in a suction chamber 234 at a secondary inlet pressure (P_{S}) and a secondary inlet temperature (T_{S}).

The venturi or ejector 230 may have exergy available in primary flow to induce the anode gas recirculated flow as the secondary flow 226 in the venturi or ejector 230. The stack pressure (ΔP_{STACK}) is the pressure loss through the AGR loop 224. The secondary flow 226 may be lifted against the stack pressure (ΔP_{STACK}).

The pressure lift (ΔP_{LIFT}) is the pressure required to overcome the pressure loses in the AGR loop 224 (ΔP_{STACK}). In some embodiments, the pressure lift (ΔP_{LIFT}) may be dominated by the pressure losses through the fuel cell stack 12 or any other component of the AGR loop 224. In some embodiments, pressure losses may be proportional to volumetric flow rate through one or more manifolds and/or channels in the AGR loop 224. In other embodiments, the volumetric flow 222 at anode inlet 212 may include a mixture of fresh fuel (e.g., H₂) as the primary flow 202 and the recirculation flow 226.

The secondary inlet pressure (P_{S}) may depend on the anode inlet manifold pressure (P_{AIM}) of the fuel cell or fuel cell stack 12 and the pressure loses in the AGR loop 224 (ΔP_{STACK}) or the required pressure lift (ΔP_{LIFT}).

$${P}_{S} = {P}_{AIM} - Δ {P}_{LIFT} \qquad ( 2 )$$

The amount of secondary flow 226 that can be entrained is dictated by the boundary conditions of the fuel cell system 10/11 and the efficiency of the venturi or ejector 230. The boundary conditions may include the primary nozzle inlet pressure (P_{O}), the secondary inlet pressure (P_{S}), the anode inlet manifold pressure (P_{AIM}) of the fuel cell or fuel cell stack 12, and/or secondary flow 226 composition. In some embodiments, the secondary flow 226 from the anode outlet 214 to the venturi or ejector inlet 232 is an adiabatic process The primary inlet temperature (T_{O}) and the secondary inlet temperature (T_{S}) of the venturi or ejector 230 may affect secondary flow 226.

As described earlier, above a certain critical current density (i__{LO_CR}) 130, the fuel cell system 10/11 is required to operate in the target anode inlet manifold pressure range indicated by the curve 160 in FIG. 2. The primary inlet pressure (P_{O}) may decrease proportionally with primary fuel demand, until the primary nozzle 236 is no longer choked (i.e., unchoked). In other embodiments, if the primary nozzle 236 is unchoked, the rate of decrease of the primary inlet pressure (P_{O}) may be non-linear and/or may be sensitive to downstream pressure, such as the secondary inlet pressure (P_{S}). In other embodiments, the primary inlet pressure (P_{O}) may decrease as the primary inlet temperature (T_{O}) decreases.

The primary inlet temperature (T_{O}) may be equal to the fuel supply temperature (T_{CV}), and/or the primary inlet temperature (T_{O}) may affect the primary flow 202. In some embodiments, the fuel cell system 10/11 may have a target mass flow rate. In other embodiments, the secondary inlet temperature (T_{S}) may influence the secondary flow 226 through geometric constraints of the secondary inlet 232 and/or the venturi or ejector 230. The thermodynamic constraints and/or venturi or ejector 230 efficiency may also influence the secondary flow 226.

The venturi or ejector 230 may be sensitive to the primary nozzle inlet pressure (P_{O}), the backpressure, and the required pressure lift (ΔP_{LIFT}). The backpressure may be an exit pressure at an ejector exit 238 (P_{C}) or may be the anode inlet manifold pressure (P_{AIM}). If there are no pressure losses to the anode inlet manifold from the venturi or ejector 230 outlet, the exit pressure at the ejector exit 238 (P_{C}) may be equal to the anode inlet manifold pressure (P_{AIM}). In some embodiment, the primary nozzle inlet pressure (P_{O}) may be a function of the current density (i) in the fuel cell system 10/11.

P_{O}=f(i) (3)

Entrainment ratio (ER), which is a measure of the performance and/or capability of the venturi or ejector 230 and may be sensitive to the primary nozzle inlet pressure (P_{O}), the backpressure (e.g., P_{C}, P_{AIM}) and/or the pressure lift (ΔP_{LIFT}). In one embodiment, as backpressure (e.g., P_{C}, P_{AIM}) increases, the venturi or ejector 230 may change from being double choked (with a stable entrainment ratio), to being in a transitioning condition (with a decreasing entrainment ratio), to having a reverse flow. Reverse flow in the venturi or ejector 230 may be undesirable as reverse flow indicates no fuel recirculation through the AGR loop 224. In some embodiments, the venturi or ejector 230 may need to offset pressure losses through the fuel cell or fuel cell stack 12 (ΔP_{STACK}), while operating against the backpressure (e.g., P_{C}, P_{AIM}).

The reversible entrainment ratio (RER) or the reversible portion of the entrainment ratio (ER) based on the thermodynamic limits, is defined as:

$$RER = - {Δχ}_{\_ M} / {Δχ}_{\_ S} \qquad ( 4 )$$

Δχ__{M} is the motive flow exergy and Δχ__{S} is the entrained flow exergy. In one embodiment, the reversible entrainment ratio (RER) of a fuel cell system 10/11 for a given set of boundary conditions can be estimated as:

$${Δχ}_{\_ M} = {C}_{P \_ A} ( Tc - To ) + {C}_{P \_ A} ln ( Tc / To ) - {R}_{\_ A} ln ( Pc / Po ) \qquad ( 5 )$$

$${Δχ}_{\_ S} = {C}_{P \_ B} ( T c - T s ) + {C}_{P \_ B} ln ( Tc / Ts ) - {R}_{\_ B} ln ( Pc / Ps ) \qquad ( 6 )$$

Subscripts _{A} and _{B} denote the primary and secondary flow properties, respectively. C_{P} is the specific heat at constant pressure. R is the gas constant (R_{UGS}/MW), R_{UGS}=universal gas constant and MW is the average molecular weight of the gas (e.g., H₂ fuel).

In one embodiment, entropy of mixing is not considered because there may not be any elements of the venturi or ejector 230 design that target recovery of chemical potential associated with entropy of mixing.

In one embodiment, if T_{S}=T_{O},

$$RER = - {R}_{\_ A} ln ( PcPo ) / {R}_{\_ B} ln ( Pc / Ps ) \qquad ( 7 )$$

In other embodiments, if the secondary inlet temperature (T_{S}) is not equal to the primary nozzle inlet temperature (T_{O}), but the process is adiabatic, the reversible entrainment ratio (RER) may be as described above.

In one embodiment, the actual entrainment ratio (ER) depends on the venturi or ejector 230 design. The venturi or ejector 230 inefficiencies or geometric constraints may prevent the reversible entrainment ratio (RER) from being achieved. In some embodiments, a high reversible entrainment ratio (RER) may be maintained across the entire operating range of the venturi or ejector 230. In other embodiments, at a minimum, the reversible entrainment ratio (RER) may be greater than the target entrainment ratio (ER__{target}) of the fuel cell system 10/11. Target entrainment ratio (ER__{target}) is the minimum required entrainment ratio (ER) of the system 10/11. In one embodiment, for a given primary inlet pressure (P_{O}), the reversible entrainment ratio (RER) may decrease with an increase in the anode inlet manifold pressure (P_{AIM}). In other embodiments, for a given primary inlet pressure (P_{O}), the reversible entrainment ratio (RER) may decrease with an increase in the pressure lift (ΔP_{LIFT}).

The effective efficiency of the venturi or ejector 230 (η_eff_ejc) is critical in determining if/or when the recirculation pump or blower 220 support is required to deliver the target entrainment ratio (ER__{target}). The effective efficiency of the venturi or ejector 230 (η_eff_ejc) may be a measure of the overall efficiency of the venturi or ejector 230 and may depend on the efficiency of the various components of the venturi or ejector 230 (η_ejc). In other embodiments, the effective efficiency of the venturi or ejector 230 (η_eff_ejc) may depend on the operating conditions of the fuel cell system 10/11. In some other embodiments, the effective efficiency of the venturi or ejector 230 (η_eff_ejc) may depend on the venturi or ejector 230 design, the position of primary nozzle 236 relative to a mixer inlet in the venturi or ejector 230, and/or efficiency of different components of the venturi or ejector 230.

The ER/RER ratio versus operating current density 108 may reach a maximum value at a certain current density and then decrease beyond that maximum current density value. In some embodiments, the maximum value of the ER/RER ratio may be reached because losses within the venturi or ejector 230 may increase with internal flow rates or because geometric constraints may limit the flow rates through the venturi or ejector 230. For example, the ER/RER ratio may increase as the current density 108 decreases from the maximum current density.

The maximum value of the ER/RER ratio may be reached because the relative losses in the ER/RER ratio due to decreasing ejector effective efficiency or other conditions may increase when the ratio of P_{O}/P_{S} drops below a certain ratio. For example, as the ratio of P_{O}/P_{S} drops, such that the primary nozzle 236 is not choked (e.g., P_{O}/P_{S}<1.9 for H₂), the efficiency of the venturi or ejector 230 may start to decline, limiting the ejector entrainment ratio (ER) capability. In some embodiments, the effective venturi or ejector 230 efficiency may be improved at low P_{O}/P_{S} ratio with careful consideration of venturi or ejector 230 design.

The maximum value of the ER/RER ratio may be reached because the venturi or ejector 230 boundary conditions may reach the venturi or ejector 230 breakdown condition. The venturi or ejector 230 boundary conditions may reduce the reversible entrainment ratio (RER) such that the ER/RER ratio may drop below a minimum required level. Alternatively, or additionally, the venturi or ejector 230 boundary conditions may reach the venturi or ejector 230 breakdown condition at low current density conditions (e.g., low P_{O}/P_{A1M}).

The fuel cell system 10/11 may have a purge flow to remove nitrogen (N₂) and/or water from the system 10/11. The purge flow may remove other gases from the fuel cell system 10/11. In some embodiments, the primary nozzle 236 of the venturi or ejector 230 may allow primary mass flow (plus any purge flow) at a maximum current density for a given fuel supply system pressure (P_{CV}), fuel supply temperature (T_{CV}), and/or the characteristics of the control valve.

The pressure and temperature boundary conditions may change with the operating current density of the fuel cell system 10/11. The backpressure (e.g., P_{C}, P_{A1M}) may be determined by the operating requirements and/or efficiency of the fuel cell stack 12. The minimum pressure lift (ΔP_{LIFT_MIN}) required to overcome the pressure loss in the AGR loop 224 is a function of the anode gas recirculation volumetric flow (AGR_{VOLFLOW}) or secondary flow 226 and/or the primary flow 202. The anode gas recirculation volumetric flow (AGR_{VOLFLOW}) is a function of the current density and the target entrainment ratio (ER_{target}).

ΔP_{LIFT_MIN}=f(AGR_{VOLFLOW})=f(i,ER_{target}) (8)

There are many trade-offs when designing and operating the fuel cell system 10/11 with a venturi or ejector 230 with or without the recirculation pump or blower 220. The venturi or ejector 230 may be sized based on the pressure and/or temperature sizing limits of the fuel cell system 10/11. As described earlier, the fuel supply system 80 supplies fuel at a fuel supply pressure (P_{CV}) and fuel supply temperature (T_{CV}). The operating range of the venturi or ejector 230 may be maximized by sizing downstream components to the fuel sizing pressure (P__{CV_MIN}) and fuel sizing temperature (T__{CV_SZ}) limits. In some embodiments, the fuel sizing pressure (P__{CV_MIN}) may be the minimum inlet pressure at the control valve. In other embodiments, fuel sizing pressure (P__{CV_MIN}) may be the pressure at the inlet of the control valve under empty pressure conditions (P_{EMPTY}).

In one embodiment, the control valve may be choked and have a pressure recovery factor (PRF) determined as follows.

$$PRF = √ [ ( {P}_{1} - {P}_{2} ) / ( {P}_{1} - {P}_{VC} ] \qquad ( 9 )$$

P₁ is the upstream pressure measured upstream of the control valve 256, such as the fuel supply pressure (P_{CV}). P₂ is a downstream pressure measured downstream of the control valve 256. P₂ is the anode inlet manifold pressure (P_{AIM}) if the fuel cell system 10/11 does not have a venturi or ejector 230 or is the primary nozzle inlet pressure (P_{O}) if the fuel cell system 10/11 has a venturi or ejector 230. P_{VC} is the pressure at the vena contracta 259 of the control valve 256 in the mechanical regulator 250.

The critical pressure ratio of the fuel (pr__{CR}) is the ratio of the primary nozzle inlet pressure (P_{O}) to the secondary inlet pressure (P_{S}) when the primary nozzle 236 is choked for a certain fuel composition. In some embodiments, the choked pressure ratio (e.g., critical pressure ratio pr__{CR}) for hydrogen is about 1.9. If the valve is choked and the fuel in the fuel cell system 10/11 is H₂, P_{VC}=P₁/1.9).

The primary nozzle 236 of the venturi or ejector 230 may be sized to deliver required fuel flow, including purge flow, at empty pressure conditions (P_{EMPTY}). Empty pressure conditions (P_{EMPTY}) comprise conditions when the primary inlet temperature (T_{O}) is equal to the fuel sizing temperature (T__{CV_SZ}) and the primary inlet pressure (P_{O}) is or is about equal to the maximum primary nozzle inlet pressure (P_{O}_M_{AX}). The maximum primary nozzle inlet pressure (P_{O_MAX}) depends on the pressure recovery factor (PRF) and the fuel sizing pressure (P__{CV_MIN}). In some embodiments, the empty pressure (P_{EMPTY}) may be from about 12 bara to about 15 bara including all pressure and pressure ranges comprised therein. In other embodiments, the empty pressure (P_{EMPTY}) may be about 12 bara.

The required fuel flow may be dependent on the actual fuel flow (primary flow 202, recirculation flow 226) and/or purge flow. In some embodiments, the operating ranges of the venturi or ejector 230 (e.g., reverse operating range, transition operating range, double choked operating range) may be managed. For example, if the fuel cell system 10/11 is operating such that the venturi or ejector 230 is operating in the transition zone, the primary nozzle 236 of the venturi or ejector 230 may be preferentially kept choked at as low a current density 108 as possible.

For a given minimum inlet pressure at the control valve 256 and sizing temperature (T__{CV_SZ}), there is a corresponding primary nozzle inlet sizing pressure (P_{O_SZ}). In some embodiments, the primary nozzle area is sized using the primary nozzle inlet sizing pressure (P_{O_SZ}) and the corresponding primary nozzle inlet sizing temperature (T_{O_SZ}).

In one embodiment, the mixer area 231 of the venturi or ejector 230 i.e. where the primary flow mixes with the secondary flow may be large enough to enable maximum entrainment ratio (ER) in the fuel cell system 10/11. The Mixer Area Ratio (MAR) is the ratio of the mixer area 231 of the venturi or ejector 230 to the primary nozzle area. The Mixer Area Ratio (MAR) of the venturi or ejector 230 may be sized based on the sizing temperature (T__{CV_SZ}).

In one embodiment, the maximum primary mass flow rate or maximum mass flow rate (m__{MAX}) is given by:

$${m}_{\_ MAX} = I 2 M \times {i}_{MAX} \times ( 1 + p r g ) \qquad ( 10 )$$

i_{MAX} is the maximum current density of the fuel cell stack 12 (e.g., about 1.6 Amps/cm²), prg is the fraction purge flow (e.g., 10%), I2M is a constant that converts current density into fuel (e.g., H₂) mass flow.

The primary nozzle inlet sizing pressure (P_{O_SZ}) depends on the fuel supply conditions and the control valve pressure at the maximum primary mass flow rate (m__{MAX}). The primary nozzle inlet sizing pressure (P_{O_SZ}) is:

P_{O_SZ}=P__{CV_MIN}/CVPR (11)

CVPR is the pressure ratio across the control valve at the maximum flow conditions. In one embodiment, the CVPR ranges from about 1.2 to about 1.9, including all values and ranges comprised therein.

In one embodiment, the control valve 256 may be wide open at the maximum primary mass flow rate (m__{MAX}), and the pressure recovery factor under maximum flow (PRF__{WO}) may be determined as:

$$PRF \_ wo = √ [ ( {P}_{\_ CV \_ MIN} - Po \_ sz ) / ( {P}_{\_ CV \_ MIN} - Pvc ) ] \qquad ( 12 )$$

$$PRF \_ wo = √ [ ( 1 - 1 / CVPR ) / ( 1 - 1 / {pr}_{\_ CR} ) ] \qquad ( 13 )$$

$$CVPR = Po \_ sz / PRF \_ wo \qquad ( 14 )$$

$$CVPR = 1 / [ 1 - PRF \_ {wo}^{2} \times ( 1 - 1 / {pr}_{\_ CR} ) ] \qquad ( 15 )$$

The pressure recovery factor under maximum flow (PRF__{WO}) may range from about 0.6 to about 0.8, including all values and ranges comprised therein. In some embodiments, the pressure recovery factor under maximum flow (PRF__{WO}) may be greater than 0.8. In other embodiments, the pressure recovery factor under maximum flow (PRF__{WO}) may be about 1.0.

The venturi or ejector 230 may be sized and designed with appropriate geometric parameters. The primary nozzle 236 and/or the mixing area 231 of the venturi or ejector 230 may be sized to meet maximum flow requirements of in the fuel cell system 10/11 in view of the pressure and/or temperature limits and ranges of the fuel supply system 80 supplying the primary flow 202 to the fuel cell system 10/11.

The choked range of a venturi or ejector 230 is inversely proportional to minimum inlet pressure at the control valve i.e. to the fuel sizing pressure (P__{CV_MIN}). In one embodiment, the ejector nozzle (primary nozzle 236) area (A_{NZL}) may be sized such that the maximum primary mass flow rate (m__{MAX}) may be achieved at the maximum the primary nozzle inlet sizing pressure (P_{O_SZ}). The required effective area of the primary nozzle (A__{EFF_NZL}) is:

$${A}_{\_ EFF \_NZL} = [ {m}_{\_ MAX} \times √ {T}_{O\_SZ} ] / [ {P}_{O\_SZ} \times {CF}_{\_ H 2} ] \qquad ( 16 )$$

CF__{H2} is constant factor, and equal to 0.578 for hydrogen. In some embodiments, the actual nozzle area (A_{NZL}) are may be larger than the effective nozzle area (A__{EFF_NZL}) to account for any inefficiencies in the primary nozzle 236.

When the primary nozzle 236 is choked, the required primary nozzle inlet pressure (P_{O}) is:

$${P}_{O} = \frac{ix}{{i}_{M A X} ( 1 + p r g )} {P}_{O\_SZ} \frac{√ ( {T}_{O} )}{√ ( {T}_{O\_SZ} )} \qquad ( 17 )$$

When the primary nozzle 236 is not choked, the required primary nozzle inlet pressure (P_{O}) is sensitive to downstream pressure (P_{S}). If the primary flow 202 in the fuel cell system 10/11 is hydrogen (H₂), the primary nozzle 236 may remain choked for hydrogen when:

$${P}_{O} / {P}_{S} > 1.9 \to {P}_{O} / ( {P}_{C} - Δ {P}_{L I F T} ) > 1.9 \qquad ( 18 )$$

$$Δ {P}_{STACK} = ( i / {i}_{M A X} ) \times Δ {P}_{REF} \times {( {P}_{C\_REF} / {P}_{C} )}^{n} \qquad ( 19 )$$

The pressure lift (ΔP_{LIFT}) is the pressure needed to overcome the pressure loss (ΔP_{STACK}) through the AGR loop 224. ΔP_{REF} is the pressure loss at maximum current flow. In some embodiments, if the primary nozzle 236 is unchoked, the slope of primary nozzle inlet pressure (P_{O}) vs secondary inlet pressure (P_{S}) may flatten. Under unchoked conditions, the ratio of primary nozzle inlet pressure (P_{O}) to the ejector exit pressure (P_{C}) i.e. P_{O}/P_{C} is smaller than what the ratio P_{O}/P_{C} would be under choked conditions. P_{C_REF} is the operating pressure at maximum current flow and n indicates the order of the relationship and can vary from 0 to 1.

For a given fuel supply constraints, the reversible entrainment ratio (RER) of the fuel cell system 10/11 may be maximized.

$$RER = - {R}_{\_ A} ln ( {P}_{C} / {P}_{O} ) / {R}_{\_ B} ln ( {P}_{C} / {P}_{S} ) \qquad ( 20 )$$

The partial derivative of the reversible entrainment ratio (RER) with respect to the primary nozzle inlet pressure (P_{O}) at constant ejector exit pressure (P_{C}) and secondary inlet pressure (P_{S}) is given by:

$$\frac{{R}_{B} ln ( {P}_{C} / {P}_{S} )}{{R}_{\_ C}} \times \frac{\partial RER}{\partial {P}_{O}} = \underline{1} \qquad ( 21 )$$

The above equation shows a positive slope, suggesting that the change in the reversible entrainment ratio (RER) is in the same direction as the change in primary nozzle inlet pressure (P_{O}). A higher primary nozzle inlet pressure (P_{O}) increases the reversible entrainment ratio (RER), all else remaining same. For a fixed ejector exit pressure (P_{C}) that is equal to the anode inlet manifold pressure (P_{AIM}) and a given secondary inlet pressure (P_{S}), the reversible entrainment ratio (RER) may be maximized by maximizing the primary nozzle inlet pressure (P_{O}).

The operating pressure or the anode inlet manifold pressure (P_{AIM}) or the backpressure can be determined from the critical pressure ratio of the fuel (pr__{CR}), the purge flow, the minimum inlet pressure at the control i.e. the fuel sizing pressure (P__{CV_MIN}), the primary fuel inlet temperature (T_{O}), and the sizing temperature (T__{CV_SZ}). The anode inlet manifold pressure (P_{AIM}) may influence the range over which the venturi or ejector 230 can meet the target entrainment ratio (ER_{target}). In some embodiments, the reversible entrainment ratio (RER) may be maximized. In other some embodiments, the primary nozzle inlet pressure (P_{O}) may be increased for given set of boundary conditions for the fuel cell system 10/11.

As described earlier, the reversible entrainment ratio (RER) is:

$$RER = - {R}_{\_ A} ln ( {P}_{C} / {P}_{O} ) / {R}_{\_ B} ln ( {P}_{C} / {P}_{S} ) \qquad ( 22 )$$

To determine how the fuel cell operating pressure (e.g., ejector exit pressure (P_{C}), anode inlet manifold pressure (P_{AIM})) influences the operating range of the venturi or ejector 230, it should be noted that:

RER>ER__{target}/η_eff_ejc (23)

η_eff_ejc is a measure of the realizable portion of the reversible entrainment ratio (RER) or effective ejector efficiency and depends on the fuel cell system 10/11 operating conditions.

If κ=(R__{A}/R__{B})(η_ejc/ER__{target}),then,(P_{C}/P_{O})^{κ}P_{S}/P_{C} (24)

The pressure loss (ΔP_{STACK}) through the AGR loop 224 is proportional to the volumetric flow.

$$Δ {P}_{STACK} = Δ {P}_{REF} \times {i}_{\_ FRAC} \times {( {P}_{AIM\_REF} / {P}_{AIM} )}^{n} \qquad ( 25 )$$

i__{FRAC} is i/i_{MAX}, if the exit pressure at the ejector exit 238 (P_{C}) is the same as the anode inlet manifold pressure (P_{AIM}), the reference anode inlet manifold pressure (P_{AIM_REF}) is, the operating pressure at maximum current flow (P_{C_REF}).

In one embodiment, the pressure loss (ΔP_{STAcK}) through the AGR loop 224 decreases as mass flow decreases. In some embodiments, the pressure loss (ΔP_{STAcK}) through the AGR loop 224 tends to decrease with higher density gas composition circulating in the AGR loop 224.

If n is 0,

$${( {P}_{C} / {P}_{O} )}^{κ} < 1 - Δ {P}_{REF} \times {i}_{\_ FRAC} / {P}_{AIM} \qquad ( 26 )$$

$$If n = 1 , {( {P}_{C} / {P}_{O} )}^{κ} < 1 - Δ {P}_{REF} \times {i}_{\_ FRAC} / {P}_{AIM\_HI} / {P}_{{AIM}^{2}} \qquad ( 27 )$$

In one embodiment, if the primary nozzle 236 is choked and if maximum anode inlet manifold pressure (P_{AIM_HI}) (about 2.5 bara) is used across the operating range of the fuel cell system 10/11, the venturi or ejector 230 may operate down to about 48% of the maximum current density with a turn down ratio of about 1.1. In other embodiments, if the primary nozzle 236 is choked and if the minimum anode inlet manifold pressures (P_{AIM_LO}) (about 1.1 bara) is used across the operating range of the fuel cell system 10/11, the venturi or ejector 230 may operate down to about 21% of the maximum current density with a turn down ratio of about 4.9.

If the minimum anode inlet manifold pressures (P_{AIM_LO}) is increased to about 1.2, the turn down ratio may decrease to about 4.0. In some embodiment, if the primary nozzle 236 is choked and the anode inlet manifold pressure (P_{AIM}) is the maximum anode inlet manifold pressure (P_{AIM_HI}) at each current density (i), the venturi or ejector 230 operation may be enabled across the entire operating range. In some further embodiments, the primary nozzle 236 may not be choked when the fuel cell system 10/11 is functioning at a lower operating range of the venturi or ejector 230.

The operating pressure of the fuel cell 20 or fuel cell stack 12 at any operating current density 108 may be set to be below a value that satisfies the following relationship:

$${( {P}_{C} / {P}_{O} )}^{κ} < 1 - Δ {P}_{LIFT} / {P}_{C} \qquad ( 28 )$$

The ejector exit pressure (P_{C}) may have an upper limit (e.g., the maximum anode inlet manifold pressure (P_{AIM_HI})) and a lower limit (e.g., the minimum anode inlet manifold pressure (P_{AIM_LO})). Alternatively, or additionally, the ejector exit pressure (P_{C}) may be sensitive to the pressure lift requirement (ΔP_{LIFT}). The minimum anode inlet manifold pressure (P_{AIM_LO}) may influence the turndown ratio of the venturi or ejector 230. Decreasing the anode inlet manifold pressure (P_{AIM}) may extend the operating range of the venturi or ejector 230.

If the minimum and maximum anode inlet manifold pressures (P_{AIM_LO} 120 and P_{AIM_HI} 110, respectively) are known, the low break point (i.e. current density) at which the minimum anode inlet manifold pressure (P_{AIM_LO}) 120 may be set (i__{LO_BRK}) and the high break point (i.e. current density) at which the maximum anode inlet manifold pressure (P_{AIM_HI}) 110 may be set (i__{HI_BRK}) can be determined. In one embodiment, under choked conditions,

$${i}_{\_ LO \_BRK} / {i}_{MAX} = {P}_{AIM\_LO} \times \frac{{pr}_{{CR}^{2}} ( 1 + prg )}{{P}_{\_CV \_MIN}} \times \frac{√ {T}_{O\_SZ}}{√ {T}_{O}} \qquad ( 29 )$$

$${i}_{\_ HI \_BRK} / {i}_{MAX} = {P}_{AIM\_HI} \times \frac{{pr}_{{CR}^{2}} ( 1 + prg )}{{P}_{\_CV \_MIN}} \times \frac{√ {T}_{O\_SZ}}{√ {T}_{O}} \qquad ( 30 )$$

Under choked conditions, if the maximum current density (i_{MAX}) 134 of the fuel cell system 10/11 is about 1.6 A/cm², the fraction of purge flow (prg) is about 10%, the primary nozzle inlet sizing temperature (T_{O_SZ}) is about 80° C., the minimum inlet pressure at the control valve i.e. the fuel sizing pressure (P__{CV_MIN}) is about 12 bara, the critical pressure ratio (pr__{CR}) is about 1.9 bara, the minimum anode inlet manifold pressures (P_{AIM_LO}) 120 is about 1.2 bara, the primary inlet fuel temperature (T_{O}) is about 80° C., the maximum anode inlet manifold pressures (P_{AIM_HI}) 110 is about 2.5 bara, the break point (i.e. current density 108) at which the minimum anode inlet manifold pressure (P_{AIM_LO}) 120 should be set i.e. the i__{LO_BRK} is determined to be about 0.64 A/cm² and the break point (i.e. current density) at which the maximum anode inlet manifold pressure (P_{AIM_HI}) 110 should be set i.e. the i__{HI_BRK} is determined to be 1.32 A/cm². The turn down ratio defined as the ratio of i__{LO_BRK} to the maximum current density of the fuel cell system 10/11 (i_{MAX}) 134 is determined to be about 2.52. If the minimum inlet pressure at the control valve i.e. the fuel sizing pressure (P__{CV_MIN}) is changed to about 12 bara and all other variables are kept the same, i__{LO_BRK} is determined to be about 0.64 A/cm², i__{HI_BRK} is determined to be 1.32 A/cm², and the turn down ratio is determined to be about 5.04.

Under choked conditions, if the venturi or ejector 230 is operating at a high current density or the primary inlet fuel temperature (T_{O}) is at about 85° C. when the primary nozzle inlet sizing temperature (T_{O_SZ}) is about 40° C., the maximum current density of the fuel cell system 10/11 (i_{MAX}) 134 is about 1.6 A/cm², the fraction of purge flow (prg) is about 10%, the minimum inlet pressure at the control valve i.e. the fuel sizing pressure (P__{CV_MIN}) is about 12 bara, the critical pressure ratio (pr__{CR}) is about 1.9 bara, the minimum anode inlet manifold pressure (P_{AIM_LO}) 120 is about 1.2 bara, the maximum anode inlet manifold pressure (P_{AIM_HI}) 110 is about 2.5 bara, the turn down ratio is about 2.69. In other embodiments, if the venturi or ejector 230 is operating at a low current density with warm fuel and the primary inlet fuel temperature (T_{O}) is at about 85° C. when the primary nozzle inlet sizing temperature (T_{O_SZ}) is about 85° C. and all other variables are kept the same, the turn down ratio decreases to about 2.52.

Under choked conditions, if the maximum current density of the fuel cell system 10/11 (i_{MAX}) 134 is about 1.6 A/cm², fraction of purge flow (prg) is about 10%, the minimum inlet pressure at the control valve i.e. the fuel sizing pressure (P__{CV_MIN}) is about 12 bara, the critical pressure ratio (pr__{CR}) is about 1.9 bara, the minimum anode inlet manifold pressure (P_{AIM_LO}) 120 is about 1.2 bara, the primary inlet fuel temperature (T_{O}) is about 85° C., the primary nozzle inlet sizing temperature (T_{O_SZ}) is about 85° C., the maximum anode inlet manifold pressure (P_{AIM_HI}) 110 is about 2.5 bara, the turn down ratio decreases to about 2.52. If the minimum anode inlet manifold pressure (P_{AIM_LO}) 120 is decreased to about 1.1 bara and all other variables are kept the same, the turn down ratio decreases to about 2.75.

If the primary nozzle 236 is not required to be choked, the low break point (i.e. current density) at which the minimum anode inlet manifold pressure P_{AIM_LO} 120 may be set (i__{LO_BRK}) and the high break point (i.e. current density) at which the maximum anode inlet manifold pressure P_{AIM_HI} 110 may be set (i__{HI_BRK}) can be determined as follows:

$${i}_{\_ FRAC} = \frac{i}{{i}_{M A X}} = \frac{{( {P}_{C} / {P}_{O} )}^{κ} - 1}{Δ {P}_{REF}} \qquad ( 31 )$$

$${P}_{O} = f ( {i}_{\_ FRAC} ) \qquad ( 32 )$$

The current density (i) may be i__{LO_BRK} or i__{HI_BRK}.

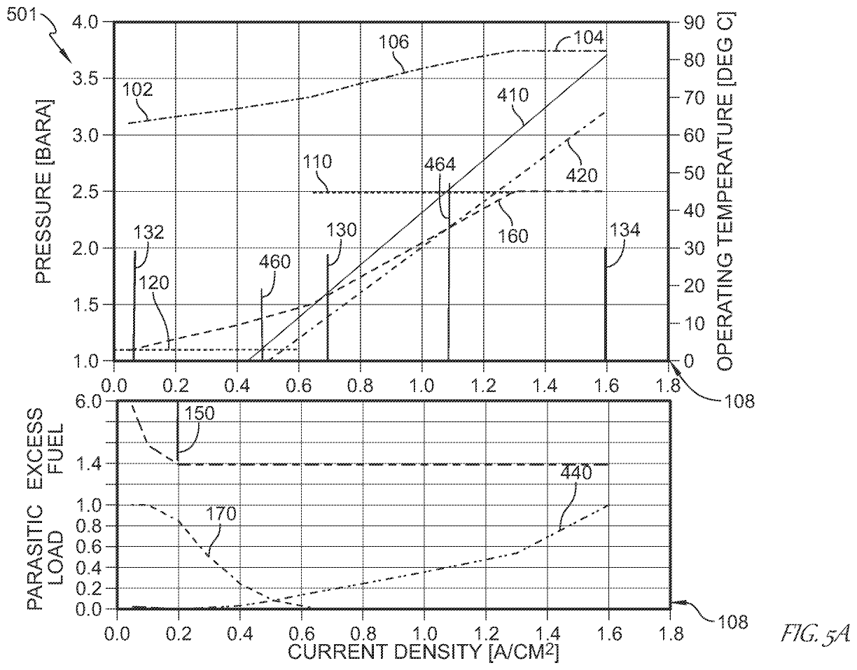

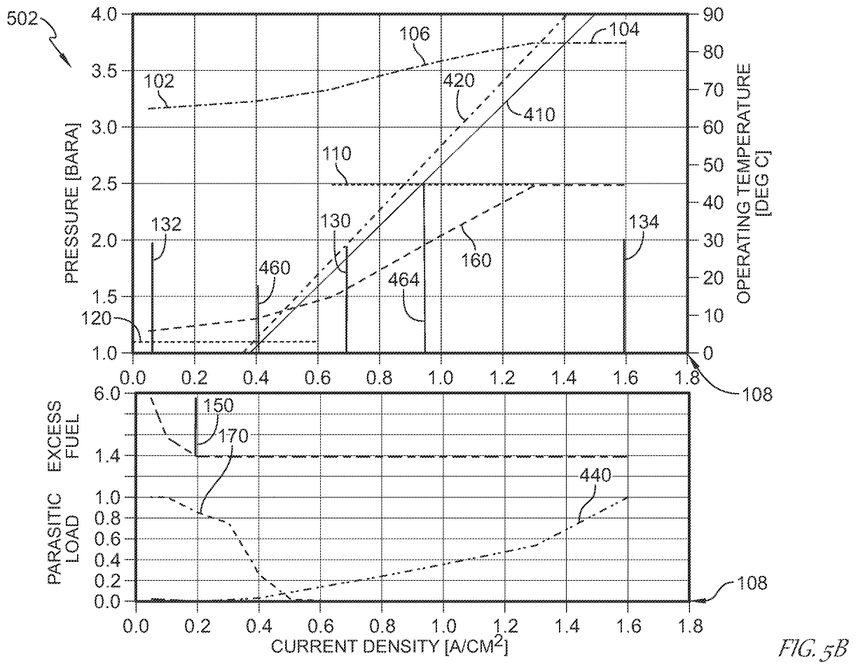

FIG. 5A shows a graph 501 that illustrates the operating range for a venturi or ejector 230 under choked conditions, and FIG. 5B shows a graph 502 that illustrates the operating range for a venturi or ejector 230 under choked and unchoked conditions. As shown in FIGS. 5A and B, the curve 160 indicates the target anode inlet manifold pressure range as determined by fuel cell stack design. Above a critical current density (i__{LO_CR}) 130, it may be essential to operate the fuel cell system 10/11 at the target anode inlet manifold pressure range which lies in the range indicated by 160. In the illustrated embodiment, the critical current density (i__{LO_CR}) 130 is about 0.7 Amps/cm². The maximum anode inlet manifold pressure (P_{AIM}) preferred by the venturi or ejector 230 i.e. maximum ejector pressure (P__{AIM_EJCT_MAX}) preferred by the venturi or ejector 230 as a function of current density is shown by the curve 410. The maximum ejector pressure (P__{AIM_EJCT_MAX}) preferred by the venturi or ejector 230 is sensitive to the primary inlet temperature (T_{O}) as shown by the curve 420.

The maximum ejector pressure (P__{AIM_EJCT_MAX}) may vary according to the limits and ranges fuel supply system 80. The current density at which the maximum ejector pressure (P__{AIM_EJCT_MAX}) curve 410 intersects the maximum anode inlet manifold pressures (P_{AIM_HI}) 110 is defined as the high current density ejector threshold (i__{HI_THV}) 464. The current density at which the maximum ejector pressure (P__{AIM_EJCT_MAX}) curve 410 intersects the minimum anode inlet manifold pressures (P_{AIM_HI}) 120 is defined as the low current density ejector threshold (i__{LO_THV}) 460.

If the maximum ejector pressure (P__{AIM_EJCT_MAX}) is greater than the anode inlet manifold pressure (P_{AIM}), the venturi or ejector 230 may operate under primary nozzle 236 choked conditions, which is a robust ejector state. In some embodiments, though the venturi or ejector 230 can still entrain flow if the anode inlet manifold pressure (P_{AIM}) is greater than the maximum ejector pressure (P__{AIM_EJCT_MAX}), the venturi or ejector 230 may become more sensitive to the boundary conditions. In other embodiments, the ability of the venturi or ejector 230 to continue to meet the entrainment ratio (ER) requirements may become more sensitive to the pressure lift (ΔP__{LIFT}) if the anode inlet manifold pressure (P_{AIM}) is greater than the maximum ejector pressure (P__{AIM_EJCT_MAX}).

The venturi or ejector 230 configuration may be sized to fully deliver the recirculation flow 226 at the critical current density (i__{LO_CR}) 130 taking into account the differential pressure across the AGR loop 224. The venturi or ejector 230 configuration may be sized to fully deliver the recirculation flow 226 without the assistance of the recirculation pump or blower 220. Absence of usage of the recirculation pump or blower 220 may result in a decrease in parasitic load as shown by the curves 170 and 440. The curve 170 shows the fraction of the recirculated flow that is delivered by the recirculation pump or blower 220 and the curve 440 shows the corresponding parasitic savings. The curve 440 illustrating the parasitic savings 440 is inversely related to the curve 170 illustrating the fraction of the recirculated flow that is delivered by the recirculation pump or blower 220.

In one embodiment, the empty pressure (P_{EMPTY}) limit may be an important parameter. The empty pressure (P_{EMPTY}) limit may be set high enough such that the venturi or ejector 230 can deliver the recirculation flow 226 without the assistance of a recirculation pump or blower 220in order to meet the recirculation flow requirement under nominal conditions

The maximum ejector pressure preferred by the venturi or ejector 230 (P__{AIM_EJCT_MAX}) may depend on a primary fuel inlet temperature (T_{O}). The curve 420 illustrates the maximum ejector pressure (P__{AIM_EJCT_MAX}) when the primary fuel inlet temperature (T_{O}) is the same as the primary nozzle inlet sizing temperature (T_{O_SZ}). Thus, the venturi or ejector 230 can be shifted into a regime under which its performance is less robust because of the primary fuel inlet temperature (T_{O}).

The minimum inlet pressure at the control valve i.e. the fuel sizing pressure (P__{CV_MIN}) may be increased to offset the primary fuel inlet temperature (T_{O}) range. For example, if the primary nozzle inlet sizing temperature (T_{O_SZ}) is 80° C., and the minimum primary fuel inlet temperature (T_{O}) is 0° C., then an offset factor is calculated as follows:

Offset Factor=√((T_{O_SZ}+273.15)/(T_{O}+273.15))=1.14 (33)

For example, the primary nozzle inlet pressure (P_{O}) may be decreased by a factor of 1.14, to offset the impact of the variation in the primary fuel inlet temperature (T_{O}). Decreasing the primary nozzle inlet pressure (P_{O}) reduces the allowable anode inlet manifold pressure (P_{AIM}) at a given operating current density and affects the turn down ratio. In some embodiments, the anode inlet manifold pressure (P_{AIM}) may be adjusted to compensate for the change in temperature. If the anode inlet manifold pressure (P_{AIM}) is not set appropriately, the venturi or ejector 230 may be adversely impacted. The empty pressure (P_{EMPTY}) may be increased by 14% to offset the impact of any variation in the primary fuel inlet temperature (T_{O}).

In one preferable embodiment, the venturi or ejector 230 is designed such that the venturi or ejector 230 can continue to robustly meet any entrainment ratio (ER) requirements at low current densities. The venturi or ejector 230 can continue to meet entrainment ratio (ER) requirements at a current density as low as the excess fuel ratio current density threshold (i__{λ_THV}) 150 in FIG. 5A and FIG. 5B. The benefits of a configuration where the venturi or ejector 230 can continue to meet entrainment ratio (ER) requirements at such low current densities is illustrated by the curve showing parasitic savings 440. The venturi or ejector 230 and recirculation pump or blower 220 may be operated simultaneously. Alternatively, or additionally, the recirculation pump or blower 220 may be sized smaller to increase the parasitic savings and/or reduce fuel cell system 10/11 cost, size, or weight.

The fuel system supply 80 and the operating conditions of the fuel cell stack 12 (e.g., pressure, temperature, recirculation flow requirements, and stack differential pressure etc.) may affect the operation and/or performance of the venturi or ejector 230. In other embodiments, the composition of the fuel cell stack 12 exhaust gas (e.g., water content, N₂ content etc.) may affect the operation and/or performance of the venturi or ejector 230.

The operation and/or performance of the venturi or ejector 230 may be improved by subjecting the primary flow to continuous temperature preconditioning. In some embodiments, temperature preconditioning may comprise heating and/or cooling. Typically, temperature preconditioning of the primary flow is done during a cold start operation.

The primary inlet temperature (T_{O}) may vary substantially during any operation of the fuel cell stack 12. In one embodiment, the primary inlet temperature (T_{O}) may range from about −40° C. to about 100° C., from about −40° C. to about −20° C., from about −20° C. to about 0° C., from about 0° C. to about 20° C., from about 20° C. to about 40° C., from about 40° C. to about 60° C., from about 60° C. to about 80° C., or from about 80° C. to about 100° C. including all values and ranges comprised therein.

The primary nozzle 236 of the venturi or ejector 230 may be sized to account for the highest temperature of the primary inlet temperature (T_{O}) range. This may result in the primary nozzle 236 being larger than otherwise required, such that at part load conditions when primary inlet temperature (T_{O}) is in middle of the allowable range, the venturi or ejector 230 operation is further challenged because the primary nozzle inlet pressure (P_{O}) required to deliver the primary flow 202 is lower than the pressure required at the highest temperature of the allowable range.

For example, the turn down ratio for the break point (i.e. current density) at which the minimum anode inlet manifold pressure (P_{AIM_LO}) 120 should be set i.e. the i__{LO_BRK} changes from 2.52 Amps/cm² when the primary nozzle inlet sizing temperature (T_{O_SZ}) is 0° C. to 2.21 Amps/cm² when the primary nozzle inlet sizing temperature (T_{O_SZ}) is 80° C. Such changes may make it challenging for the venturi or ejector 230 to deliver the required entrainment ratio (ER) at the low load conditions.

In one embodiment, variable primary inlet fuel temperatures (T_{O}) results in low temperature of the venturi or ejector 230 outlet flow. Since the entrainment flow 226 is saturated, at low primary inlet temperature (T_{O}), the relative humidity (RH) of the venturi or ejector 230 outlet can exceed RH=1 (i.e., RH=2, 2.1, 2.2, 3, etc.). When RH exceeds 1, condensation issues may arise in the manifold or piping at the anode inlet 212. In other embodiments, droplets may condense on the primary flow jet.

Low primary inlet temperature (T_{O}) can cause temperature gradients in the venturi or ejector 230. Such temperature gradients may lead to stress failures within the venturi or ejector 230, manifold into and/or of the venturi or ejector 230 and/or fuel cell stack 12. To mitigate the effect of temperature gradients, heat may be exchanged ahead of primary nozzle 236 inlet to maintain the fuel at a fixed temperature (for e.g., at the fuel cell operating temperature). Temperature preconditioning of the primary flow 202 ahead of primary nozzle 236 inlet may be based on the primary nozzle inlet sizing temperature (T_{O_SZ}) which may vary with the operating conditions of the fuel cell system 10/11.

The primary inlet temperature (T_{O}) may be maintained a fixed temperature by exchanging heat with a component of the fuel cell stack 12 such as the coolant 36, post compressor air stream 37 etc. Such heat exchange may result in a predictable venturi or ejector 230 outlet composition and temperature. In some embodiments, the heat exchange may comprise one or more pipes, tubes or other equipment directing the primary flow in proximity to components with which to exchange heat. In one embodiment, the venturi or ejector 230 may also operate more robustly across a wider range of boundary conditions.

With the ability to variably control the inlet temperature, the operating range of the venturi or ejector 230 may be extended to lower current densities 108. The venturi or ejector 230 may operate at a colder temperature under high current densities 108, and the primary nozzle 236 of the venturi or ejector 230 may be sized to operate at this lower temperature. At lower operating current densities (i.e., at or around i__{LO_BRK}), the temperature of the primary flow 202 at the inlet (T_{O}) may be increased by implementing temperature preconditioning. Such configuration would require the primary nozzle inlet pressure (P_{O}) to increase in order to meet mass flow requirement of the fuel cell system 10/11.

For example, if the primary nozzle 236 was sized to operate at 40° C., and the primary inlet fuel temperature (T_{O}) when the fuel cell system 10/11 is operating at current densities 108 around i__{LO_BRK} is increased to 80° C., the turndown ratio would increase from 2.52 to 2.69. Thus, the operating range of the venturi or ejector 230 may be extended and any sizing requirements to be imposed on the recirculation pump or blower 220 may be minimized at the increased primary inlet fuel temperatures (T_{O}). In some embodiments, minimizing the pressure loss in the fuel cell system 10/11 through the temperature preconditioning device may maximize the benefits of preconditioning.

During transients, electrical energy or waste heat from the fuel cell stack 12 may be diverted to a heater or a heat storage devise to heat the primary flow 202 and increase the primary fuel inlet temperature (T_{O}). For example, if the primary fuel inlet temperature (T_{O}) was increased by heating, the primary inlet pressure (P_{O}) would increase to compensate for the temperature rise and minimize any sizing requirements to be imposed on the recirculation pump or blower 220. For example, if the primary flow 202 normally operated at 80° C. at part load conditions, and was heated to 150° C. during transient state, then the current density at the transition point (i__{TRS_BRK}) point could be reduced by about 9%.

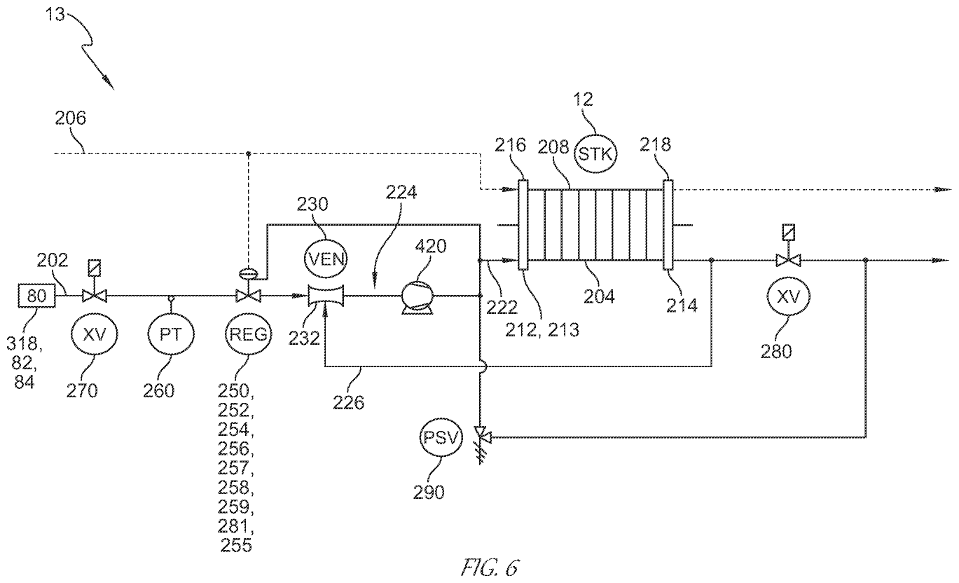

The configuration of the recirculation pump or blower 220 in relation to the venturi or ejector 230 may enhance the operation and/or performance of the venturi or ejector 230. The recirculation pump or blower 220 supports the operation and/or performance of the venturi or ejector 230. In some embodiments, as shown in FIGS. 3 and 4, if the recirculation pump or blower 220 is upstream of the venturi or ejector 230, the flow rate through the recirculation pump or blower 220 corresponds to the recirculated flow through the AGR loop 224. For example, if the entrainment ratio (ER) is equal to 2.0, then flow through the recirculation pump or blower 220 (Q) is ⅔ of the total fuel 222 flow (primary flow 202+recirculation fuel flow 226). In other embodiments, as shown in FIG. 6, if the recirculation pump or blower 520 is downstream of the venturi or ejector 230, then fuel flow through the recirculation pump or blower 520 (Q) is equal to the total fuel flow 222 in the fuel cell system 13.

The parasitic load of recirculation pump or blower 220 is defined as being equal to the pressure differential across the AGR loop 224 multiplied by the flow through the recirculation pump or blower 220/520 (Q). Thus, with same pressure differential across the AGR loop 224, the parasitic load of a recirculation pump or blower 520 downstream of the venturi or ejector 230 would be higher than if the recirculation pump or blower 220 was upstream of the venturi or ejector 230.

In one embodiment, the performance of the venturi or ejector 230 degrades when the ratio of primary nozzle inlet pressure (P_{O}) to the secondary inlet pressure (P_{S}) i.e. P_{O}/P_{S} drops below a critical ratio (pr__{CR}). In some embodiments, the venturi or ejector 230 may be designed to operate efficiently below the critical ratio (pr__{CR}).

The fuel cell system 10/11/13 may not have a recirculation pump or blower 220/520. In the absence of a recirculation pump or blower 220/520, the secondary inlet pressure (P_{S}) is the difference between the anode inlet manifold pressure (P_{AIM}) and the pressure differential across the fuel cell or fuel cell stack 12 (ΔP__{FC}).

$${P}_{O} = {P}_{AIM} - Δ {P}_{\_ FC} \qquad ( 34 )$$

As the current density demand decreases, the primary flow 202 decreases and the primary nozzle inlet pressure (P_{O}) drops. The anode inlet manifold pressure (P_{AIM}) and the pressure differential across the fuel cell (ΔP__{FC}) depend on the operation and design of the fuel cell stack 12. If the current density demand decreases such that the ratio of primary nozzle inlet pressure (P_{O}) to the secondary inlet pressure (P_{S}) i.e. P_{O}/P_{S} will be too low to support full entrainment ratio (ER) requirement, a recirculation pump 220/520 may be added to the fuel cell system 10/11/13.

The Mach number in the primary nozzle 236 may be used to determine when a recirculation pump or blower 220/520 is needed. As the Mach number in the primary nozzle 236 drops below 1.0, efficiency of entrainment tends to degrade. For example, if the Mach number in the primary nozzle 236 is about 0.54, but the boundary conditions are such that the reversible entrainment ratio (RER) is insufficient to meet the pressure lift (ΔP__{LIFT}) requirements, a recirculation pump or blower 220/520 may be needed to be added to the fuel cell system 10/11/13.

If the recirculation pump or blower 220 is upstream of the venturi or ejector 230 or in series with the venturi or ejector 230, the presence of the recirculation pump or blower 220 will decrease the pressure lift (ΔP__{LIFT}), but also increase the secondary inlet pressure (P_{S}). The pressure lift (ΔP__{LIFT}) is reduced in proportion to the pressure lift capability of the recirculation pump or blower 220 (ΔP__{BLWR}). The secondary inlet pressure (P_{S}) will also depend on the pressure lift capability of the recirculation pump or blower 220 (ΔP__{BLWR}). The Mach number in the primary nozzle 236 may drop, resulting in a decrease in the efficiency of the operation and/or performance of the venturi or ejector 230. In some embodiments, the efficiency drop may be steep.

$$Δ {P}_{\_ LIFT} = Δ {P}_{\_ FC} - Δ {P}_{\_ BLWR} \qquad ( 35 )$$

$${P}_{S} = {P}_{AIM} - Δ {P}_{\_ FC} + Δ {P}_{\_ BLWR} \qquad ( 36 )$$

If the recirculation pump or blower 520 is downstream of the venturi or ejector 230, the recirculation pump or blower 520 will reduce the pressure lift (AP LIFT), but not affect the secondary inlet pressure (P_{S}). Thus the ratio of primary nozzle inlet pressure (P_{O}) to the secondary inlet pressure (P_{S}) i.e. P_{O}/P_{S} is higher than if the recirculation pump or blower 220 is upstream of the venturi or ejector 230. The Mach number in the primary nozzle 236 will not change, and the reverse entrainment ratio (RER) will increase, enabling the fuel cell system 13 to overcome the pressure lift (ΔP__{LIFT}) requirement without any decrease in the efficiency of the operation and/or performance of the venturi or ejector 230.

$$Δ {P}_{\_ LIFT} = Δ {P}_{\_ FC} - Δ {P}_{\_ BLWR} \qquad ( 37 )$$

$${P}_{S} = {P}_{AIM} - Δ {P}_{\_ FC} \qquad ( 38 )$$

If the recirculation pump or blower 220 is upstream of the venturi or ejector 230, the recirculation pump or blower 220 may support the entire entrainment ratio (ER) and the pressure differential across the AGR loop 224 (ΔP_{STACK}). If the recirculation pump or blower 220 is upstream of the venturi or ejector 230, the recirculation pump or blower 220 may be able to deliver about 10% of the reverse entrainment ratio (RER) at a Mach number of 0.48 in the primary nozzle 236. If the recirculation pump or blower 520 is downstream of the venturi or ejector 230, the recirculation pump or blower 520 may be able to deliver about 50% of the reverse entrainment ratio (RER) at a Mach number of 0.54 in the primary nozzle 236. As the operating and/or performance efficiency of the venturi or ejector 230 drops with the Mach number, a recirculation pump or blower 520 configured downstream of the venturi or ejector 230 will maximize the operating and/or performance efficiency of the venturi or ejector 230.

The following described aspects of the present invention are contemplated and non-limiting.

A first aspect of the present invention relates to a fuel cell system having an ejector. The ejector has a first fuel entering a first inlet at a first pressure (P_{O}) and a second fuel entering a second inlet at a second pressure (P_{S}). The first fuel and the second fuel exit an ejector exit at an ejector exit pressure. The ejector is sized to fully deliver the second fuel for a required entrainment ratio (ER) at a critical current density. The fuel cell system is required to operate at an operating current density and at an operating pressure within an operating pressure range. The operating pressure is at or above the critical current density and the ejector has an effective efficiency (η).

A second aspect of the present invention relates to a method of operating a fuel cell system. The method of operating the fuel cell system includes the steps of flowing a first fuel at a first pressure (P_{O}) through a first inlet in an ejector, flowing a second fuel at a second pressure (P_{S}) through a second inlet in the ejector, exiting a mixture of the first fuel and second fuel at an ejector exit with an ejector exit pressure (P_{C}), sizing the ejector to fully deliver the second fuel at a critical current density, and operating the fuel cell system at an operating current density and with an operating pressure. The operating pressure is at or above the critical current density and the ejector as an effective efficiency (η).

In the first and second aspect of the present invention, the operating pressure may range from a low pressure to a high pressure. In the first and second aspect of the present invention, the operating pressure of the fuel cell system at the operating current density may be set to be below the ejector exit pressure (P_{C}) that satisfies the relationship (P_{C}/P_{O})^{κ}<P_{S}/P_{C}. In the first and second aspect of the present invention, κ=(R__{A}/R__{B}) (η/ER), R_{A} may be the gas constant of the first fuel and R_{B} may be the gas constant of the second fuel.

In the first and second aspect of the present invention, the fuel cell system may include an anode gas recirculation loop and the ejector size may depend on a pressure loss (ΔP_{LIFT}) through the anode gas recirculation loop. In the first and second aspect of the present invention, the pressure loss (ΔP_{LIFT}) may vary with operating conditions including operating current density and operating pressure. In the first and second aspect of the present invention, (P_{C}/P_{O})^{κ}<1−ΔP_{LIFT}/P_{C}. In the first and second aspect of the present invention, κ=(R__{A}/R_{B}) (η/ER), R_{A} may be the gas constant of the first fuel and R_{B} may be the gas constant of the second fuel.

In the first and second aspect of the present invention, the ejector may be sized to fully deliver the second fuel for the required entrainment ratio (ER) at the critical current density without assistance of a blower.

In the first and second aspect of the present invention, the first pressure (P_{O}) may depend on a temperature of the first fuel at the first inlet.

In the first and second aspect of the present invention, the ejector may be sized based on a sizing temperature of the first fuel at the first inlet. In the first and second aspect of the present invention, the first fuel may be preconditioned before entering the first inlet. In the first and second aspect of the present invention, preconditioning may include heating or cooling the temperature of the first fuel up to the sizing temperature. In the first and second aspect of the present invention, the sizing temperature may vary with or may depend on operating conditions of the fuel cell system. In the first and second aspect of the present invention, the heating or cooling of the first fuel may include using heat exchange with other components of the fuel cell system. The other components may include a coolant or a compressor air stream. In the first and second aspect of the present invention, the heating or cooling of the first fuel may include one or more pipes or tubes directing the first fuel in proximity to other components of the fuel cell system.

In the first and second aspect of the present invention, the ejector may be sized to meet the target entrainment ratio at or above a current density threshold. In the first and second aspect of the present invention, the target entrainment ratio may be based on a minimum excess fuel ratio or a minimum anode gas inlet humidity.

In the first and second aspect of the present invention, the fuel cell system may further include a blower upstream or downstream the ejector.

In the first and second aspect of the present invention, the effective efficiency (i) may vary with operating conditions of the ejector.

In the second aspect of the present invention, the method may further include preconditioning the first fuel before entering the first inlet.

In the second aspect of the present invention, the method may further include operating a blower upstream or downstream of the ejector.

The features illustrated or described in connection with one exemplary embodiment or aspect may be combined with any other feature or element of any other embodiment or aspect described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that other embodiments may be utilized and that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third”, and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including”, or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell system comprising:
an ejector with a first fuel entering a first inlet at a first pressure (P_{O}), a second fuel entering a second inlet at a second pressure (P_{S}), and the first fuel and second fuel exiting an ejector exit at an ejector exit pressure (P_{C}),
wherein the ejector is sized to fully deliver the second fuel for a required entrainment ratio (ER) at a critical current density,
wherein the fuel cell system is required to operate at an operating current density and at an operating pressure within an operating pressure range,
wherein the operating pressure is at or above the critical current density, and wherein the ejector has an effective efficiency (η).

2. The system of claim 1, wherein the operating pressure range ranges from a low pressure to a high pressure, wherein the operating pressure of the fuel cell system at the operating current density is set to be below the ejector exit pressure (P_{C}) that satisfies the relationship (P_{C}/P_{O})^{κ}<P_{S}/P_{C}, and wherein κ=(R__{A}/R__{B}) (η/ER), R_{A} is the gas constant of the first fuel and R_{B} is the gas constant of the second fuel.

3. The system of claim 1, wherein the fuel cell system comprises an anode gas recirculation loop and the ejector size depends on a pressure loss (ΔP_{LIFT}) through the anode gas recirculation loop, wherein the pressure loss (ΔP_{LIFT}) varies with operating conditions including the operating current density and operating pressure, wherein (P_{C}/P_{O})^{κ}<1−ΔP_{LIFT}/P_{C}, and wherein κ=(R__{A}/R__{B}) (η/ER), R_{A} is the gas constant of the first fuel and R_{B} is the gas constant of the second fuel.

4. The system of claim 1, wherein the ejector is sized to fully deliver the second fuel for the required entrainment ratio (ER) at the critical current density without assistance of a blower.

5. The system of claim 1, wherein the first pressure (P_{O}) depends on a temperature of the first fuel at the first inlet.

6. The system of claim 4, wherein the ejector is sized based on a sizing temperature of the first fuel at the first inlet.

7. The system of claim 6, wherein the first fuel is preconditioned before entering the first inlet, wherein preconditioning comprises heating or cooling the temperature of the first fuel up to the sizing temperature, and wherein the sizing temperature can vary with operating conditions of the system.

8. The system of claim 7, wherein the heating or cooling the first fuel comprises using heat exchange with other components of the fuel cell system such as a coolant or compressor air stream.

9. The system of claim 7, wherein the heating or cooling the first fuel comprises one or more pipes or tubes directing the first fuel in proximity to other components of the fuel cell system.

10. The system of claim 1, wherein the ejector is sized to meet the target entrainment ratio at or above a current density threshold, and wherein the target entrainment ratio is based on a minimum excess fuel ratio or a minimum anode gas inlet humidity.

11. The system of claim 1, wherein the fuel cell system further comprises a blower upstream or downstream the ejector.

12. The system of claim 1, wherein the effective efficiency (η) varies with operating conditions of the ejector.

13. A method of operating a fuel cell system comprising:
flowing a first fuel at a first pressure (P_{O}) through a first inlet in an ejector,
flowing a second fuel at a second pressure (P_{S}) through a second inlet in the ejector,
exiting a mixture of the first fuel and second fuel at an ejector exit with an ejector exit pressure (P_{C}),
sizing the ejector to fully deliver the second fuel at a critical current density, and
operating the fuel cell system at an operating current density and with an operating pressure,
wherein the operating pressure is at or above the critical current density, and
wherein the ejector has an effective efficiency (η).

14. The method of claim 13, wherein the operating pressure is comprised in an operating pressure range that ranges from a low pressure to a high pressure, wherein the operating pressure of the system at the operating current density is set to be below the ejector exit pressure (P_{C}) that satisfies the relationship (P_{C}/P_{O})^{κ}<P_{S}/P_{C}, and wherein κ=(R__{A}/R__{B}) (η/ER), R_{A} R_{A} is the gas constant of the first fuel and R_{B} is the gas constant of the second fuel.

15. The method of claim 13, wherein the fuel cell system comprises an anode gas recirculation loop and the ejector is sized based on a pressure loss (ΔP_{LIFT}) through the anode gas recirculation loop, wherein the pressure loss (ΔP_{LIFT}) varies with operating conditions, wherein (P_{C}/P_{O})^{κ}<1−ΔP_{LIFT}/P_{C}, and wherein κ=(R__{A}/R__{B}) (η/ER), R_{A} is the gas constant of the first fuel and R_{B} is the gas constant of the second fuel.

16. The method of claim 13, wherein the ejector is sized to fully deliver the second fuel for the required entrainment ratio (ER) at the critical current density without the assistance of a blower.

17. The method of claim 13, wherein the ejector is sized to meet a target entrainment ratio (ER) and wherein the target entrainment ratio depends on a minimum excess fuel ratio or a minimum anode gas inlet humidity.

18. The method of claim 13, wherein the method comprises preconditioning the first fuel before entering the first inlet, and wherein the preconditioning comprises heating or cooling the first fuel up to a sizing temperature, and wherein the sizing temperature depends on operating conditions of the fuel cell system.

19. The method of claim 18, wherein the heating or cooling the first fuel comprises using heat exchange with other components of the fuel cell system.

20. The method of claim 13, wherein the method further comprises operating a blower upstream or downstream the ejector.
